(19) United States
(12) Patent Application Publication
(10) Pub. No.: US 2025/0274798 A1
(43) Pub. Date: Aug. 28, 2025

(54) COMMUNICATION APPARATUS AND COMMUNICATION METHOD FOR ENHANCED SENSING BY PROXY

(71) Applicant: Panasonic Intellectual Property Corporation of America, Torrance, CA (US)

(72) Inventors: Rojan CHITRAKAR, Singapore (SG); Yoshio URABE, Nara (JP); Hiroyuki MOTOZUKA, Kanagawa (JP)

(21) Appl. No.: 18/859,492

(22) PCT Filed: Feb. 28, 2023
(86) PCT No.: PCT/SG2023/050119

§ 371 Date: Oct. 23, 2024

(30) Foreign Application Priority Data
Apr. 28, 2022 (SG) 10202204596X
May 19, 2022 (SG) 10202205297W

(51) Int. Cl. H04W 24/10; H04B 17/318

(52) U.S. Cl. CPC H04W 24/10; H04B 17/328

(57) ABSTRACT

The present disclosure provides a communication apparatus and a communication method for sensing by proxy, the communication apparatus comprising: circuitry, which, in operation, is configured to generate a request frame indicating a condition to be used by a second communication apparatus to select one or more links, each of the one or more links attached with to one or more third communication apparatuses; a transmitter, which, in operation, transmits the request frame to the second communication apparatus to request the second communication apparatus to perform a measurement on the one or more links; and a receiver, which, in operation, receives a report frame from the second communication apparatus carrying one or more reports of the measurement corresponding to the one or more links.

### TECHNICAL FIELD

The present disclosure relates to communication apparatuses and methods for sensing, and more particularly for sensing by proxy.

### BACKGROUND

A wireless local area network (WLAN) sensing is under development by Institute of Electrical and Electronics Engineers (IEEE) 802.11 bf Task Group. In the task group, Sensing by Proxy (SBP), which enables a client to obtain sensing measurement using multiple radio links, is proposed, but the details of the protocol/procedure to select best links/STAs for the SBP procedure has not been discussed in the Task Group.

While a Wi-Fi coverage with multiple links is very common these days, blindly measuring and reporting all possible links in the SBP reporting phase will cause a big overhead in the Wi-Fi link used for the reporting.

There is thus a need for communication apparatuses and methods for enhanced sensing by proxy that provide feasible technical solutions to address the issues, more particularly, to enable an SBP initiator and/or responder to select the best links/STAs for the SBP procedure to reduce the reporting overhead.

Furthermore, other desirable features and characteristics will become apparent from the subsequent detailed description and the appended claims, taken in conjunction with the accompanying drawings and this background of the disclosure. SUMMARY

Non-limiting and exemplary embodiments facilitate providing communication apparatuses and communication methods for collaborative sounding procedure in context of WLAN.

In a first aspect, the present disclosure provides a first communication apparatus comprising: circuitry, which, in operation, is configured to generate a request frame indicating a condition to be used by a second communication apparatus to select one or more links, each of the one or more links attached to one or more third communication apparatuses; a transmitter, which, in operation, transmits the request frame to the second communication apparatus to request the second communication apparatus to perform a measurement on the one or more links; and a receiver, which, in operation, receives a report frame from the second communication apparatus carrying one or more reports of the measurement corresponding to the one or more links.

In a second aspect, the present disclosure provides a second communication apparatus: a receiver, which, in operation, receives a request frame from a first communication apparatus, the request frame indicating a condition to select one or more links, each of the one or more links attached to one or more third communication apparatuses; circuitry, which, in operation, is configured to generate a report frame carrying one or more reports of a measurement corresponding to the one or more links; and a transmitter, which, in operation, transmits the report frame to the first communication apparatus.

In a third aspect, the present disclosure provides a communication method implemented by a first communication apparatus comprising: generating a request frame indicating a condition to be used by a second communication apparatus to select one or more links, each of the one or more links attached to one or more third communication apparatuses; transmitting the request frame to the second communication apparatus to request the second communication apparatus to perform a measurement on the one or more links; and receiving a report frame, from the second communication apparatus, carrying one or more reports of the measurement corresponding to the one or more links.

In a fourth aspect, the present disclosure provides a communication method implemented by a second communication apparatus comprising: receiving a request frame from a first communication apparatus, the request frame indicating a condition to select one or more links, each of the one or more links attached to one or more third communication apparatuses; generating a report frame carrying one or more reports of a measurement corresponding to the one or more links; and transmitting the report frame to the first communication apparatus.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 depicts a schematic diagram illustrating a single-user (SU) communication between an access point (AP) and a station (STA) in a MIMO (multiple-input multiple-output) wireless network.

FIG. 2 depicts a schematic diagram illustrating downlink multi-user (MU) communication between an AP and multiple STAs in a MIMO wireless network.

FIG. 3 depicts a schematic diagram illustrating a trigger-based (TB) uplink MU communication between an AP and multiple STAs in a MIMO wireless network.

FIG. 4 depicts a schematic diagram illustrating communications between a STA (client 0) and an AP for a basic SBP procedure.

FIG. 5 shows a schematic diagram showing a floor plan and devices located therein.

FIG. 6 depicts a schematic view of a communication apparatus according to the present disclosure.

FIG. 7 shows a flowchart illustrating a communication method implemented by a first communication apparatus according to various embodiments of the present disclosure.

FIG. 8 shows a flowchart illustrating a communication method implemented by a second communication apparatus according to various embodiments of the present disclosure.

FIG. 9 shows a flowchart illustrating an overview of a sensing by proxy procedure between an AP and three non-AP STAs according to a first embodiment of the present disclosure.

FIG. 10 shows a flowchart illustrating a detailed procedural flow of the sensing by proxy procedure between the AR and the three non-AP STAs in FIG. 9.

FIG. 11 shows a schematic diagram illustrating connections among the AP and the three non-AP STAs in FIG. 9.

FIG. 12 shows an example format of an Extended Capability Element used for basic discovery according to an embodiment of the present disclosure.

FIG. 13A shows an example format of an SBP Request frame according to the first embodiment of the present disclosure.

FIG. 13B shows an example format of a Protected SBP Request frame according to the first embodiment of the present disclosure.

FIG. 14A shows an example format of an SBP Response frame according to the first embodiment of the present disclosure.

FIG. 14B shows an example format of a Protected SBP Response frame according to the first embodiment of the present disclosure.

FIG. 15 shows an example format of the SBP Parameter Element field in the SBP Request/Response frames in FIGS. 13A-14B.

FIG. 16 shows an example format of the SBP Link Info Element field in the SBP Response frames in FIGS. 14A and 14B.

FIG. 17 shows an example format of an SBP Report frame according to the first embodiment of the present disclosure.

FIG. 18A show an example format of an SBP Termination frame according to the first embodiment of the present disclosure.

FIG. 18B show an example format of a Protected SBP Termination frame according to the first embodiment of the present disclosure.

FIG. 19 shows a flowchart illustrating communications between an SBP Initiator (non-AP STA) and an SBP Responder (AP) for sensing by proxy according to the first embodiment of the present disclosure.

FIG. 20A shows a flowchart illustrating an overview of a sensing by proxy procedure between an AP and three non-AP STAs according to a second embodiment of the present disclosure.

FIG. 20B shows a schematic diagram illustrating connections among the AP and the three non-AP STAs in FIG. 20A.

FIG. 21 shows a flowchart illustrating a detailed procedural flow of the sensing by proxy procedure between the AP and the three non-AP STAs in FIG. 20A.

FIG. 22 shows an example visualization of enhanced client discovery results.

FIG. 23 shows an example format of an SBP Parameter Element field of an SBP Request frame according to the second embodiment of the present disclosure.

FIG. 24A show an example format of an SBP Response according to the second embodiment of the present disclosure.

FIG. 24B show an example format of a Protected SBP Response according to the second embodiment of the present disclosure.

FIG. 25 shows an example format of the SBP Link Info Element field in the SBP Response frames in FIGS. 24A and 24B according to the embodiment.

FIG. 26 shows an example format of an SBP Report frame according to the second embodiment of the present disclosure.

FIG. 27A shows a schematic diagram showing a floor plan and devices located therein together with two example implementations of a sensing by proxy procedure according to the second embodiment of the present disclosure.

FIG. 27B shows another example format of an SBP Request frame according to the second embodiment of the present disclosure.

FIG. 28 shows a flowchart illustrating an overview of a sensing by proxy procedure between an AP and three non-AP STAs according to a third embodiment of the present disclosure.

FIG. 29 shows a flowchart illustrating a detailed procedural flow of the sensing by proxy procedure between an AP and two non-AP STAs according to the third embodiment of the present disclosure.

FIG. 30 an example format of a Sensing Measurement Setup Request frame according to the third embodiment of the present disclosure.

FIG. 31 shows an example format of a Protected Authorization Validation Request frame according to the third embodiment of the present disclosure.

FIG. 32 shows an example format of a Protected Authorization Validation Response frame according to the third embodiment of the present disclosure.

FIG. 33A shows an example format of an SBP Response frame according to the third embodiment of the present disclosure.

FIG. 33B shows an example format of a Protected SBP Response frame according to the third embodiment of the present disclosure.

FIG. 34 shows an example format of an SBP Request frame according to the third embodiment of the present disclosure.

FIG. 35 shows an example configuration of a communication apparatus.

FIG. 36 shows another example configuration of a communication apparatus.

Skilled artisans will appreciate that elements in the figures are illustrated for simplicity and clarity and have not necessarily been depicted to scale. For example, the dimensions of some of the elements in the illustrations, block diagrams or flow charts may be exaggerated in respect to other elements to help an accurate understanding of the present embodiments.

### DETAILED DESCRIPTION

Some embodiments of the present disclosure will be described, by way of example only, with reference to the drawings. Like reference numerals and characters in the drawings refer to like elements or equivalents.

In the following paragraphs, certain exemplifying embodiments are explained with reference to an access point (AP) and a station (STA) for sensing by proxy, especially in a multiple-input multiple-output (MIMO) wireless network.

In the context of IEEE 802.11 (Wi-Fi) technologies, a station, which is interchangeably referred to as a STA, is a communication apparatus that has the capability to use the 802.11 protocol. Based on the IEEE 802.11-2016 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user” “user device”, and “node” are often used interchangeably.

Likewise, an AP, which may be interchangeably referred to as a wireless access point (WAP) in the context of IEEE 80211 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In a MIMO wireless network, “multiple” refers to multiple antennas used simultaneously for transmission and multiple antennas used simultaneously for reception, over a radio channel. In this regard, “multiple-input” refers to multiple transmitter antennas, which input a radio signal into the channel, and “multiple-output” refers to multiple receiver antennas, which receive the radio signal from the channel and into the receiver. For example, in an N×M MIMO network system, N is the number of transmitter antennas, M is the number of receiver antennas, and N may or may not be equal to M. For the sake of simplicity, the respective numbers of transmitter antennas and receiver antennas are not discussed further in the present disclosure.

In a MIMO wireless network, single-user (SU) communications and multi-user (MU) communications can be deployed for communications between communication apparatuses such as APs and STAs. MIMO wireless network has benefits like spatial multiplexing and spatial diversity, which enable higher data rates and robustness through the use of multiple spatial streams. According to various embodiments, the term “spatial stream” may be used interchangeably with the term “space-time stream” (or STS).

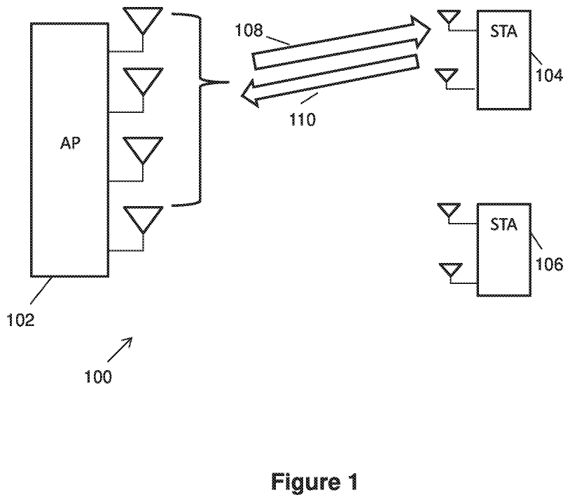

FIG. 1 depicts a schematic diagram illustrating a SU communication 100 between an AP 102 and a STA 104 in a MIMO wireless network. As shown, the MIMO wireless network may include one or more STAs (e.g., STA 104, STA 106, etc.). If the SU communication 100 in a channel is carried out over whole channel bandwidth, it is called full bandwidth SU communication. If the SU communication 100 in a channel is carried out over a part of the channel bandwidth (e.g., one or more 20 MHz subchannels within the channel is punctured), it is called punctured SU communication. In the SU communication 100, the AP 102 transmits multiple space-time streams using multiple antennas (e.g., four antennas as shown in FIG. 1) with all the space-time streams directed to a single communication apparatus, i.e. the STA 104. For the sake of simplicity, the multiple space-time streams directed to the STA 104 are illustrated as a grouped data transmission arrow 108 directed to the STA 104.

The SU communication 100 can be configured for bi-directional transmissions. As shown in FIG. 1, in the SU communication 100, the STA 104 may transmit multiple space-time streams using multiple antennas (e.g., two antennas as shown in FIG. 1) with all the space-time streams directed to the AP 102. For the sake of simplicity, the multiple space-time streams directed to the AP 102 are illustrated as a grouped data transmission arrow 110 directed to the AP 102.

As such, the SU communication 100 depicted in FIG. 1 enables both uplink and downlink SU transmissions in a MIMO wireless network.

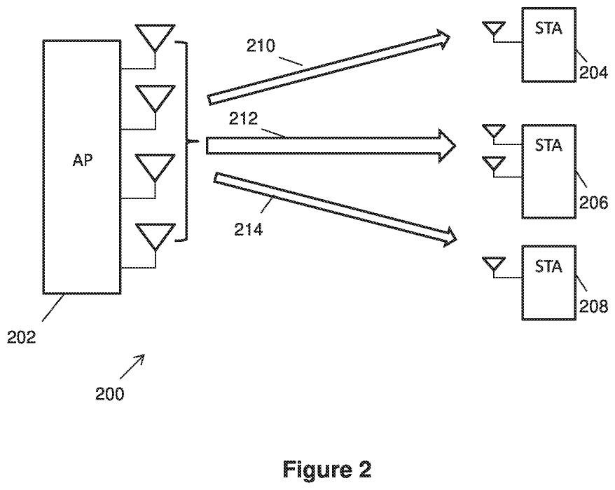

FIG. 2 depicts a schematic diagram illustrating a downlink MU (multiple-user) communication 200 between an AP 202 and multiple STAs 204, 206, 208 in a MIMO wireless network. The MIMO wireless network may include one or more STAs (e.g., STA 204, STA 206, STA 208, etc.). The MU communication 200 can be an OFDMA (orthogonal frequency division multiple access) communications or a MU-MIMO communication. For an OFDMA communication in a channel, the AP 202 transmits multiple streams simultaneously to the STAs 204, 206, 208 in the network at different resource units (RUs) within the channel bandwidth. For a MU-MIMO communication in a channel, the AP 202 transmits multiple streams simultaneously to the STAs 204, 206, 208 at same RU(s) within the channel bandwidth using multiple antennas via spatial mapping or precoding techniques. If the RU(s) at which the OFDMA or MU-MIMO communication occurs occupy whole channel bandwidth, the OFDMA or MU-MIMO communications is called full bandwidth OFDMA or MU-MIMO communications. If the RU(s) at which the OFDMA or MU-MIMO communication occurs occupy a part of channel bandwidth (e.g., one or more 20 MHz subchannel within the channel is punctured), the OFDMA or MU-MIMO communication is called punctured OFDMA or MU-MIMO communications. For example, two space-time streams may be directed to the STA 206, another space-time stream may be directed to the STA 204, and yet another space-time stream may be directed to the STA 208. For the sake of simplicity, the two space-time streams directed to the STA 206 are illustrated as a grouped data transmission arrow 212, the space-time stream directed to the STA 204 is illustrated as a data transmission arrow 210, and the space-time stream directed to the STA 208 is illustrated as a data transmission arrow 214.

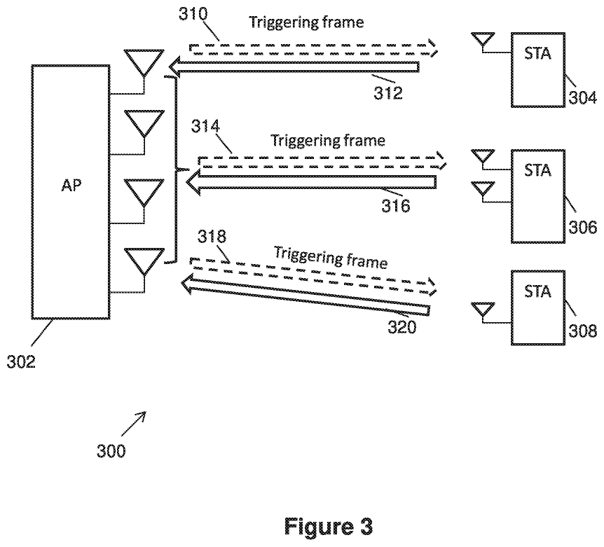

To enable uplink MU transmissions, trigger-based communication is provided to the MIMO wireless network. In this regard, FIG. 3 depicts a schematic diagram illustrating a trigger-based (TB) uplink MU communication 300 between an AP 302 and multiple STAs 304, 306, 308 in a MIMO wireless network.

Since there are multiple STAs 304, 306, 308 respectively participating in the trigger-based uplink MU communication, the AP 302 needs to coordinate simultaneous transmissions of multiple STAs 304, 306, 308.

To do so, as shown in FIG. 3, the AP 302 transmits triggering frames 310, 314, 318 simultaneously to STAs 304, 306, 308 respectively to indicate user-specific resource allocation information (e.g., the number of space-time streams, a starting STS number and the allocated RUs) that each STA can use. In response to the triggering frames, STAs 304, 306, 308 may then transmit their respective space-time streams simultaneously to the AP 302 according to the user-specific resource allocation information indicated in the triggering frames 310, 314, 318. For example, two space-time streams may be directed to the AP 302 from STA 306, another space-time stream may be directed to the AP 302 from STA 304, and yet another space-time stream may be directed to the AP 302 from STA 308. For the sake of simplicity, the two space-time streams directed to the AP 302 from STA 306 are illustrated as a grouped data transmission arrow 316, the space-time stream directed to the AP 302 from STA 304 is illustrated as a data transmission arrow 312, and the space-time stream directed to the AP 302 from STA 308 is illustrated as a data transmission arrow 320.

Due to packet/PPDU (physical layer protocol data unit) based transmission and distributed MAC (medium access control) scheme in 802.11 WLAN, time scheduling (e.g., TDMA (time division multiple access)-like periodic time slot assignment for data transmission) does not exist in 802.11 WLAN. Frequency and spatial resource scheduling is performed on a packet basis. In other words, resource allocation information is on a PPDU basis.

According to various embodiments, WLAN supports non-trigger-based communications as illustrated in FIG. 1 and trigger-based communications as illustrated in FIG. 2. In non-trigger-based communications, a communication apparatus transmits a PPDU to one other communication apparatus or more than one other communication apparatuses in an unsolicited manner. In trigger-based communications, a communication apparatus transmits a PPDU to one other communication apparatus or more than one other communication apparatuses only after a soliciting triggering frame is received.

According to the present disclosure, the term “sensing initiator” refers to a device which initiates a sensing session with a STA (herein referred to as “client”) and requests for a sensing result from the STA. The term “sensing responder” is a STA which responds to the sensing initiator and participates in the sensing session. In various embodiments below, unless otherwise stated, the term “initiator” and “responder” refer to as “sensing initiator” and “sensing responder”, respectively. Typically (e.g., in Trigger Based (TB) sensing measurements), the initiator is an AR, while the responders are non-AP STAs; however this need not always be the case and at times non-AP STAs can also be the initiator, and an AR can be a responder (e.g., in Non-TB sensing measurements, or Fine Timing Measurements (FTM)/Ranging).

In contrast to “sensing initiator” and “sensing responder”, the term “Sensing By Proxy (SBP) initiator” refers to a STA which initiate an SBP procedure and requests a device (e.g., AP or sensing initiator) to be a proxy sensing initiator to initiate a sensing session and request for a sensing result from another STA (e.g., the device's client) on its behalf. The term “SBP responder” refers to a device which responds to the SBP initiator and agrees to participate in the SBP procedure to be a proxy sensing initiator. It is noted that an SBP initiator can be a sensing responder or one of multiple sensing responders of an SBP responder (sensing initiator).

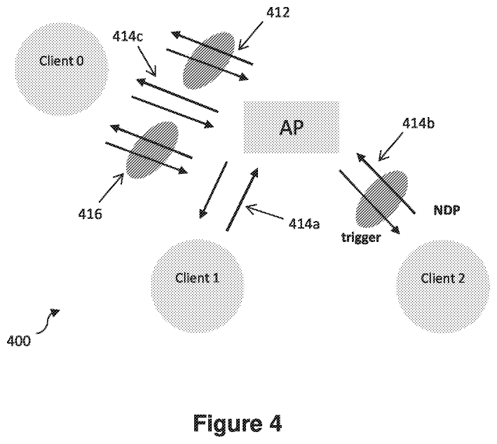

As mentioned earlier, SBP, which enables a client to obtain sensing measurement using multiple radio links, is introduced in IEEE 802.11 bf. FIG. 4 depicts a schematic diagram 400 illustrating communications between a STA (client 0) and an AP for a basic SBP procedure. According to the basic concept, a Sensing by Proxy procedure includes an SBP procedure setup, a sensing measurement, an SBP procedure reporting and an SBP procedure termination. During SBP procedure setup, a client (e.g., client 0) requests the AP to obtain sensing measurements with other clients (e.g., clients 1 and 2). The AP is configured to act as a proxy-initiator for the requesting client. In various embodiments illustrated in the present disclosure, such requesting client is referred to as SBP requesting STA or SBP Initiator while the AP is referred to proxy AP or SBP Responder. The proxy is established by exchanging SBP request/response frames 412 between the SBP Initiator and the SBP Responder. The AP then performs sensing measurement with one or more clients (e.g. clients 1 and 2), for example, by exchanging measurement setup request/response frames to establish sessions and/or measurement report frame 414a, 414b during measurement instance(s). In the FIG. 4 example, the SBP Initiator is one of the clients, and the AP may also perform sensing measurement with the SBP Initiator by exchanging the relevant frames 414c. During SBP procedure Reporting, the AP which obtained the client's measurement reports then reports them to the SBP Initiator, for example, by sending an SBP report frame 416. After the SBP procedure Reporting, the SBP procedure may be terminated at any time by either the SBP Initiator or the SBP Responder by transmitting an SBP Termination frame (not shown).

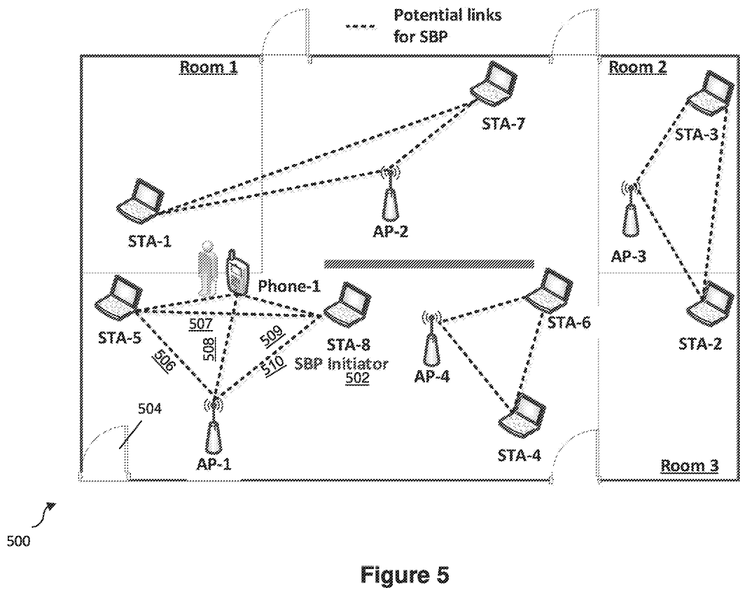

As mentioned earlier, there are client discovery problems in SBP procedure. As whole house/office/building/entity coverage with Multi-AP Wi-Fi (e.g., with Mesh Wi-Fi or enterprise Wi-Fi network) is very common these days, blindly measuring and reporting all possible links in the SBP reporting phase will cause a big overhead in the Wi-Fi link used for reporting. FIG. 5 shows a schematic diagram 500 showing a floor plan and devices located therein. In this figure, STA-8 is an SBP Initiator 502 configured to perform human tracking on persons entering the floor from the door 504. There may be 15 possible links between the devices, as illustrated using lines between devices, but only a few links such as links 506, 507, 508, 509 and 510 (among STA-5, phone-1, AP-1) may be of interest for the human tracking sensing application tasked with human tracking near the vicinity of the door 504.

There is thus a need for communication apparatuses and methods for enhanced sensing by proxy that enables an SBP initiator to select the best links/STAs for the SBP procedure to reduce the reporting overhead.

The present disclosure illustrates a sensing by proxy procedure that enables a non-AP STA to be an SBP initiator and select STAs or links for sensing measurement during SBP negotiation phase. The links may be AP to STA links (e.g., Initiator-to-Responder (I2R) or Responder-to-Initiator (R2I)) or STA to STA links (e.g., Responder-to-Responder (R2R)). The present disclosure also seeks to propose related signalling and frame format for the sensing by proxy procedure.

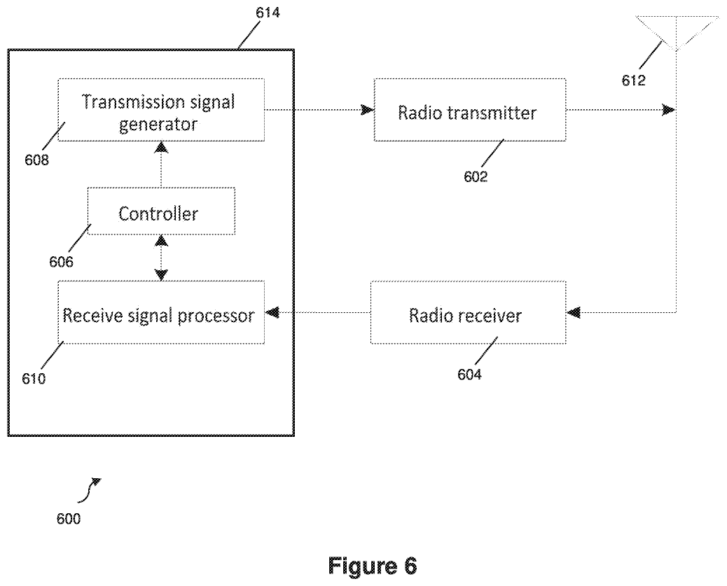

FIG. 6 depicts a schematic view of a communication apparatus 600 according to the present disclosure. The communication apparatus 600 may also be implemented as a sensing initiator, a sensing responder, an SBP initiator or an SBP responder.

As shown in FIG. 6, the communication apparatus 600 may include circuitry 614, at least one radio transmitter 802, at least one radio receiver 604, and at least one antenna 612 (for the sake of simplicity, only one antenna is depicted in FIG. 6 for illustration purposes). The circuitry 614 may include at least one controller 606 for use in software and hardware aided execution of tasks that the at least one controller 606 is designed to perform, including control of communications with one or more other communication apparatuses in a MIMO wireless network. The circuitry 614 may further include at least one transmission signal generator 608 and at least one receive signal processor 610. The at least one controller 606 may control the at least one transmission signal generator 608 for generating MAC frames and PPDUs) to be sent through the at least one radio transmitter 602 to one or more other communication apparatuses, wherein the MAC frames, for example, may be Client Discovery Query/Request/Response frame, Sensing Measurement Setup Request/Response frame, SBP Request/Response frame, SBP Report frame, Sensing Measurement Report frame, Polling Trigger frame, Sounding Trigger frame, NFRP Trigger frame, Sensing Trigger frame, Sensing NDPA; and the PPDU, for example, may be PPDUs used for non-trigger-based communications, PPDUs used for trigger-based sounding/sensing measurement procedure, non-trigger-based sounding/sensing measurement procedure, PPDUs used for trigger-based downlink transmissions if the communication apparatus 600 is an AP, or PPDUs used for trigger-based uplink transmissions if the communication apparatus 600 is a STA. The at least one controller 606 may control the at least one receive signal processor 610 for processing MAC frames and PPDUs received through the at least one radio receiver 604 from the one or more other communication apparatuses under the control of the at least one controller 606, wherein the MAC frames, for example, may be Client Discovery Query/Request/Response frame, Sensing Measurement Setup Request/Response frame, SBP Request/Response frame, SBP Report frame, Sensing Measurement Report frame, Polling Trigger frame, Sounding Trigger frame, NFRP Trigger frame, Sensing Trigger frame, Sensing NDPA; and the PPDU, for example, may be PPDUs used for non-trigger-based communications, PPDUs used for trigger-based sounding/sensing measurement procedure, non-trigger-based sounding/sensing measurement procedure PPDUs used for trigger-based uplink transmissions if the communication apparatus 600 is an AP, or PPDUs used for trigger-based downlink transmissions if the communication apparatus 600 is a STA. The at least one transmission signal generator 608 and the at least one receive signal processor 610 may be stand-alone modules of the communication apparatus 600 that communicate with the at least one controller 606 for the above-mentioned functions, as shown in FIG. 6. Alternatively, the at least one transmission signal generator 608 and the at least one receive signal processor 610 may be included in the at least one controller 606. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 802, at least one radio receiver 604, and at least one antenna 612 may be controlled by the at least one controller 606.

The communication apparatus 600, when in operation, provides functions required for sensing by proxy. For example, the communication apparatus 600 may be an SBP initiator, and the circuitry 614 (for example the at least one transmission signal generator 608 of the circuitry 614) may be configured to generate a request frame indicating a condition to be used by a second communication apparatus (e.g., SBP responder) to select one or more links, each of the one or more links attached to one or more third communication apparatuses (e.g., sensing responders), and the at least one radio transmitter 602 may then transmit the request frame to the second communication apparatus to request the second communication apparatus to perform a measurement on the one or more links. The at least one radio receiver 604 may subsequently receives a report frame from the second communication apparatus carrying one or more reports of the measurement corresponding to the one or more links.

In an embodiment, the at least one radio receiver 604 further receives a response frame from the second communication apparatus carrying the information identifying each of the one or more links prior to receiving the report frame from the second communication apparatus carrying the one or more reports of the measurement corresponding to the one or more links.

In another embodiment, the at least one radio receiver 604 further receives a validation request frame to request for verification information indicating that the communication apparatus 600 is authorized to receive the one or more reports. The circuitry 614 (for example the at least one receive signal processor 610 and the at least one transmission signal generator 608 of the circuitry 614, respectively) may be configured to process the validation request frame and generate a validation response frame comprising the verification information. The at least one radio transmitter 602 may then transmit the validation response frame.

The communication apparatus 600 may be a sensing SBP responder, and the at least one radio receiver 604 receives a request frame from a first communication apparatus (e.g., SBP initiator) which indicates a condition to select one or more links, each of the one or more links attached to one or more third communication apparatuses (e.g., sensing responders. The circuitry 614 (for example the at least one transmission signal generator 608 of the circuitry 614) may be configured to generate a report frame carrying one or more reports of a measurement corresponding to the one or more links. The at least one radio transmitter 602 may then transmit the report frame to the first communication apparatus.

In one embodiment, the circuitry 614 (for example the at least one transmission signal generator 608 of the circuitry 614) may be configured to generate a setup request frame for each of the one or more third communication apparatuses to setup the measurement on the each of the one or more third communication apparatuses, the setup request frame comprising an identifier or an address of the communication apparatus 600. The at least one radio transmitter 602 may then transmit the setup request frame to the first communication apparatus.

In another embodiment, the at least one receiver 604 receives a validation request frame from one of the one or more third communication apparatuses to request for verification information indicating that the first communication apparatus is authorized to receive a measurement report from the one of the one or more third communication apparatuses. The at least one radio transmitter 602 may then transmit the validation request frame to the communication apparatus 600. Subsequently, the at least one receiver 604 further receives a validation response frame comprising the verification information from the communication apparatus 600, and the at least one radio transmitter 602 may then transmit the validation response frame to the one of the one or more third communication apparatuses.

Yet in another embodiment, the circuitry 614 (for example the at least one transmission signal generator 608 of the circuitry 614) may be configured to assign a different setup identifier to each of the one or more links and generate a response frame subsequent to receiving the request frame comprising the different setup identifier assigned to the ach of the one or more links, and the report frame carries information of the different setup identifier identifying the each of the one or more links corresponding to the one or more report of the measurement.

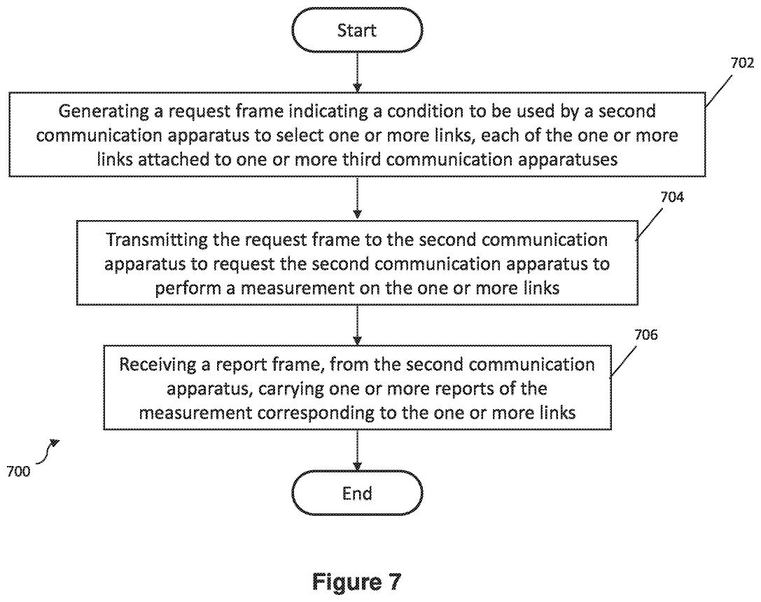

FIG. 7 shows a flowchart 700 illustrating a communication method implemented by a first communication apparatus such as an SBP initiator according to various embodiments of the present disclosure. In step 702, a step of generating a request frame indicating a condition to be used by a second communication apparatus (e.g., SBP responder) to select one or more links is carried out, each of the one or more links attached to one or more third communication apparatuses (e.g., sensing responders). In step 704, a step of transmitting the request frame to the second communication apparatus to request the second communication apparatus to perform a measurement on the one or more links is carried out. In step 706, a step of receiving a report frame, from the second communication apparatus, carrying one or more reports of the measurement corresponding to the one or more links is carried out.

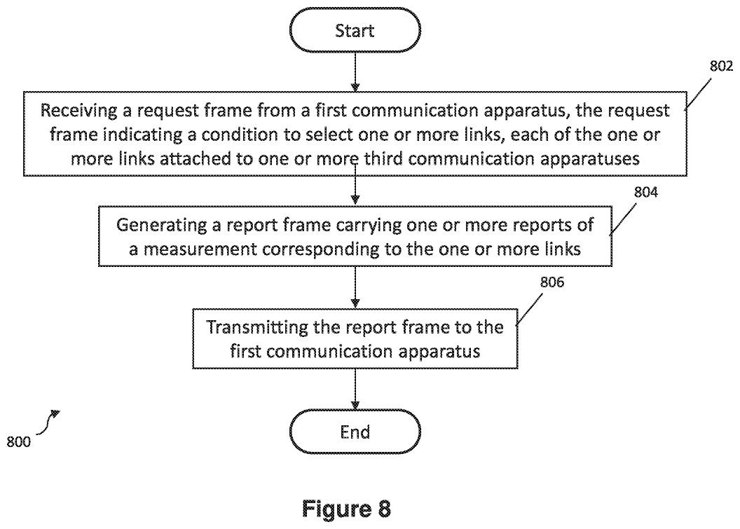

FIG. 8 shows a flowchart 800 illustrating a communication method implemented by a second communication apparatus such as an SBP responder according to various embodiments of the present disclosure. In step 802, a step of receiving a request frame from a first communication apparatus (e.g., SBP initiator) is carried out, the request frame indicating a condition to select one or more links, each of the one or more links attached to one or more third communication apparatuses. In step 804, a step of receiving a report frame carrying one or more reports of a measurement corresponding to the one or more links. In step 806, a step of transmitting the report frame to the first communication apparatus is carried out.

In the following paragraphs, a first embodiment of the present disclosure where a sensing by proxy procedure, where a non-AP STA indicates a condition for an AP to select one or more other non-AP STAs or links, is described.

According to the first embodiment, during an SBP setup, an SBP initiator (non-AP STA) specifies, in an SBP request, basic sensing operation attributes (e.g., sampling rate, report type, etc.) and information as a condition that helps an SBP responder (AP) to select a STA(s) or link(s). The SBP Responder then decides/selects the STAs/links to be used for sensing measurements based on the condition (i.e. attributes and information).

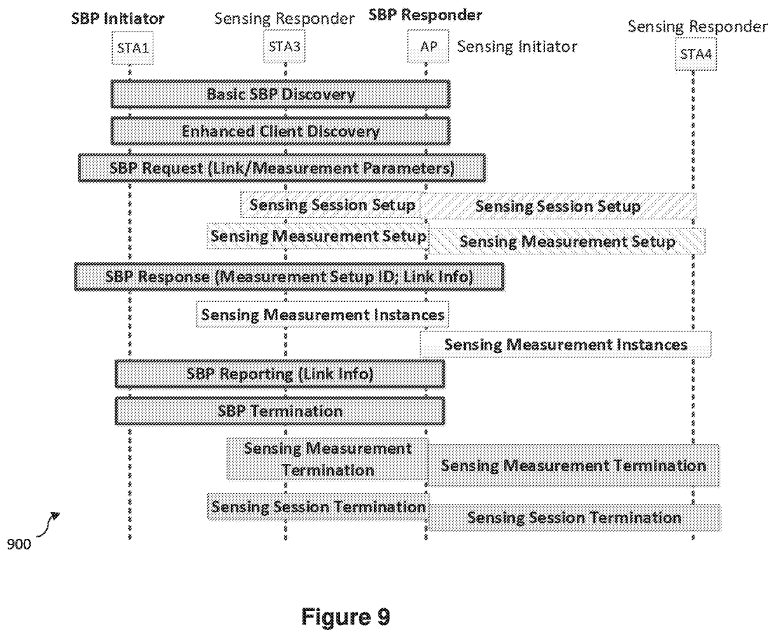

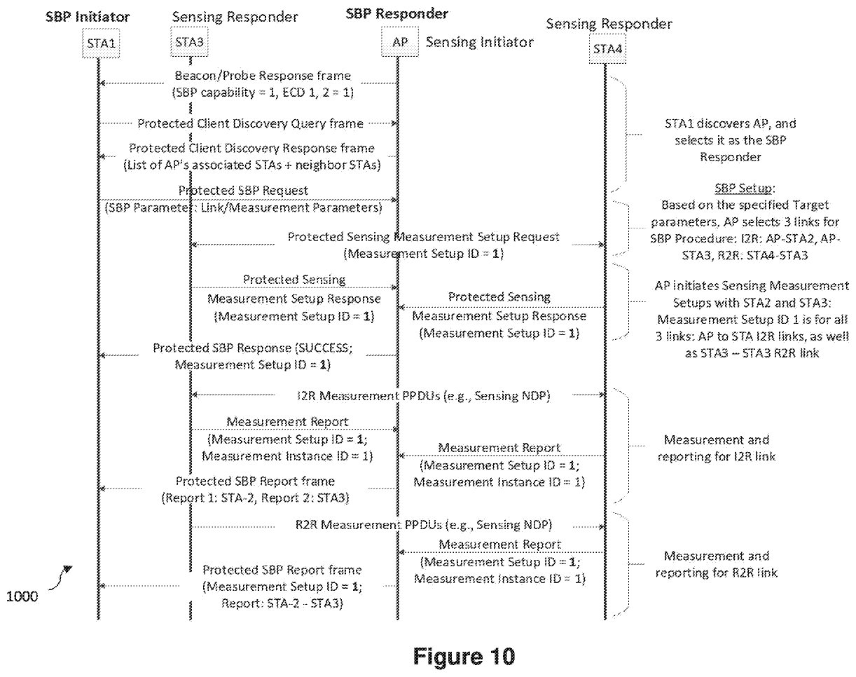

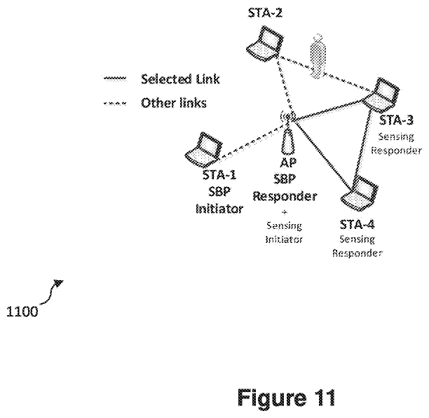

FIG. 9 shows a flowchart 900 illustrating an overview of a sensing by proxy procedure between an AP and three non-AP STAs (STA1, STA4, STA3) according to the first embodiment of the present disclosure. FIG. 10 shows a flowchart 1000 illustrating a detailed procedural flow of the sensing by proxy procedure between the AP and the three non-AP STAs in FIG. 9. FIG. 11 shows a schematic diagram 1100 illustrating connections among the AP and the three non-AP STAs in FIG. 9. Firstly, the AP advertises its capability to support enhanced client discovery and basic information about associated non-AP STAs (e.g., count/number of associated STAs etc.) using a Beacon/Probe Response frame. The STA1 may perform a basic SBP discovery and discover an AP's support of the SBP function. The STA1 may then select the AP as its SBP responder.

STA1 may then initiate an enhanced client discovery procedure by transmitting a protected client discovery query frame to request the AP to provide a list of non-AP STAs (associated non-AP STAs and optionally unassociated non-AP STAs). The AP then transmits a protected Client Discovery Response frame with the requested list of non-AP STAs and, optionally, their respective neighboring STAs, and the enhanced client discovery procedure ends. In this enhanced client discovery procedure, the SBP initiator discovers the information of AP and potential sensing responders. In particular, the AP already has basic information about associated STAs, e.g., their operating channel(s), sensing capabilities and R2R sensing capabilities etc., The SBP Initiator (STA1) can obtained such information from the AP using Level 1 Client Discovery Query. Although it is not shown in the figure, upon receiving request from the SBP Initiator (or even on its own), the AP may collect other relevant information from its associated STAs for example their location/position of the STAs, RSSI (or propagation loss) to/from the STAs (to represent a distance between the STAs and the AP) and information about the STA's neighboring STAs including link metrics etc. With that, the SBP Initiator can obtain such relevant information about the AP's associated STAs (and their neighboring STAs) from the AP using Level 2 Client Discovery Query. Based on the above information, the SBP Initiator can select one or more APs as SBP Responder(s) as well as one or more non-AP STAs as target sensing responders for the SBP Procedure. Alternatively, if, for example, the AP doesn't support Enhanced Client Discovery, or in addition to the information collected via Enhanced Client Discovery, the SBP Initiator may also use information received via other means (e.g., IP/MAC Addresses provided by the upper layer applications etc.) to select the SBP Responder and sensing responders for the SBP Procedure.

Alternatively, it is also possible that initially SBP Initiator requests measurement results from “all/many” available links but subsequently selects a subset of links that are most suitable for the sensing application in subsequent SBP request(s). The link selection may be based on statistical analysis of the sensing measurement reports for the links; for example, the links in which the CSI feedback are insensitive to the needs of the sensing application may be omitted in later SBP requests.

It is noted that the SBP initiator (STA1) may either be associated with the AP (SBP Responder) in which case it is assumed to have already completed the usual authentication/association procedure with the AP as well as setting up of security association (SA), for example, through a 4-way handshake prior to the initiation of the SBP Request; or, it may be unassociated with the AP in which case it is assumed to have already completed the setting up of security associated with the AP, for example, through a pre-association security negotiation (PASN) through a 3-way handshake prior to the initiation of the SBP request.

STA1 discovers AP through the client discovery procedure and select it as the SBP responder. It then initiates an SBP procedure and requests the AP to be a proxy sensing initiator on its behalf by transmitting a Protected SBP Request frame carrying link/measurement parameters relating to SBP links and measurement attributes such as minimum receive signal strength indicator (RSSI) or received channel power indicator (RCPI) and number of measurement links. Based on the link/measurement parameters, the AP then decides 3 STAs/links that are more relevant for the sensing measurements (in this case, an I2R link attached to STA4, an I2R link attached to STA3 as well as STA4-to-STA3 R2R link), and initiates a sensing session setup and a sensing measurement setup with the selected STAs (STA4, STA3) by transmitting a Protected Sensing Measurement Setup Request frame to them. In this embodiment, a same measurement setup identifier (ID) is assigned to all different measurement links (e.g., AP-to-STA I2R links as well as STA-to-STA3 R2R link) for the SBP procedure. Each of STA4, STA3 (sensing responders) receiving the Protected Sensing Measurement Setup Request frame then transmits a Protected Sensing Measurement Setup Response frame back to the AP (SBP Responder or proxy sensing initiator) indicating a successful sensing measurement setup.

The AP then transmits a Protected SBP Response frame to indicate a successful setup with its sensing responders and also indicates the measurement setup ID selected for the SBP procedure back to the SBP Initiator (STA1) to complete the SBP setup.

Subsequently, the AP perform sensing measurement instances with STA4 and STA3 by first transmitting I2R Measurement PPDUs (e.g., Sensing NDP) to STA4 and STA3. STA4 and STA3, in response, measures the respective channels based upon receiving the I2R Measurement PPDUs, and if requested, transmit their measurement reports. The measurement reports comprise their assigned measurement setup ID “1”. After collecting the measurement reports on its links, the AP then consolidate the measurement reports and transmits a Protected SBP Report frame comprising the measurement reports of its I2R links with STA4 and STA3 to STA1. In the report frame, Link information such as the STA IDs or other IDs which can be used to identify the I2R measurement links is included. Alternatively or additionally, R2R measurement and reporting for R2R link may also be carried out during the same measurement instance (Measurement Instance ID 1). In this case, STA4 transmits a R2R Measurement PPDUs (e.g., Sensing NDP) to STA3, and STA3, in response, transmits a measurement report to the AP. The measurement report comprises the assigned measurement setup ID “1”. Upon receipt of the measurement reports, the AP then transmits a Protected SBP Report frame comprising the measurement report of the R2R link between STA4 and STA3 to STA1. Similarly, Link Information such as the STA IDs or other IDs which can be used to identify the R2R measurement link is included in the SBP report frame.

Alternatively, as illustrated in FIG. 9, the AP may perform measurements on different links/STAs at different measurement instances (different Measurement Instance ID but same Measurement Setup ID), for example, perform a sensing measurement with STA3 at first measurement instance under Measurement Instance ID “1” and then a sensing measurement with STA4 at second measurement instance under Measurement Instance ID “2”. The AP then transmits an SBP Report frame comprising the measurement reports of STA4 and STA3 received in different measurement instances to STA1. Similarly, in the report frame, Link information such as the STA IDs or other IDs which can be used to identify the measurement links is included.

Finally, after SBP procedure, STA1 may initiate an SBP procedure termination by transmitting an SBP Termination frame (not shown) to the AP. The AP then perform sensing measurement termination and sensing session termination with STA4 and STA3 for the sensing measurement setup IDs corresponding to the SBP procedure.

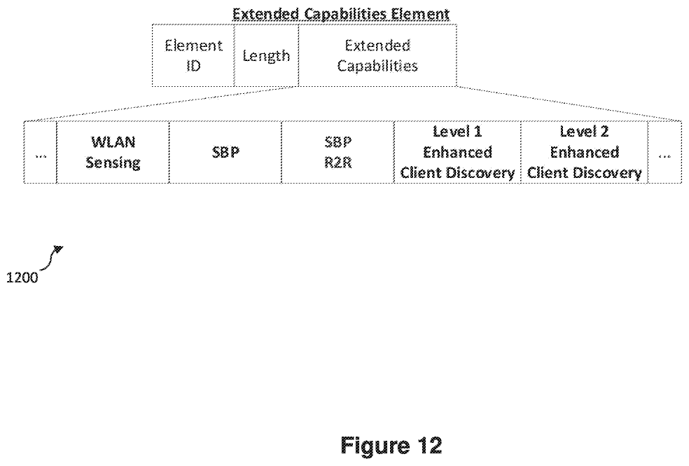

FIG. 12 shows an example format of an Extended Capability Element 1200 used for basic discovery according to an embodiment of the present disclosure. The Extended Capability Element 1200 is used to indicate an STA's (AP or non-AP) capabilities and support of certain services and communication features. It comprises an Element ID field, a Length field and an Extended Capabilities field. The Extended Capabilities field comprises a WLAN sensing subfield, an SBP subfield, an SBP R2R subfield, a Level Enhanced Client Discovery subfield and a Level 2 Enhanced Client Discovery subfield. The SBP subfield indicates that the AP is capable of providing the Sensing By Proxy Service with its associated STAs. The SBP R2R indicates that the AP is capable of providing the Sensing By Proxy Service for R2R links with its associated STAs. The Level 1 and Level 2 Enhanced Client Discovery subfields indicates that the AP/non-AP STA is capable of performing Level 1 and Level 2 Enhanced Client Discovery. For Level 1 Enhanced Client Discovery, the AP is capable of providing a list of non-AP STAs (associated non-AP STAs and optionally unassociated non-AP STAs), while for Level 2 Enhanced Client Discovery, the AP is capable of providing detailed information of neighboring clients/devices located within a radio range of a particular non-AP STAs (associated or unassociated non-AP STA).

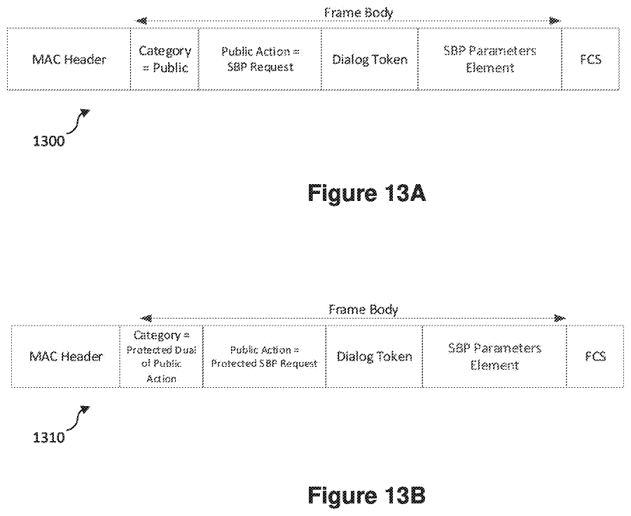

In the present disclosure, an SBP initiator and an SBP Responder exchange SBP Request/Response/Termination frames to setup SBP procedure if security associated (SA) does not exist between them; otherwise, they exchange Protected SBP Request/Response frames. According to the first embodiment of the present disclosure, FIGS. 13A and 13B show example formats of an SBP Request frame 1300 and a Protected SBP Request frame 1310, respectively. The SBP Request frame 1300 comprises a MAC Header (Frame Control field, Duration field, Recipient Address (RA) field and Transmitter Address (TA) field), a Category field which is set to “Public”, a Public Action field which is set to “SBP Request”, a Dialog Token field, an SBP Parameter Element and a frame checking sequence (FCS) field. The SBP Protected frame 1310 comprises a MAC Header (Frame Control field, Duration field, RA field and TA field), a Category field which is set to “Protected Dual of Public Action”, a Public Action field which is set to “Protected SBP Request”, a Dialog Token field, an SBP Parameter Element field and a FCS field.

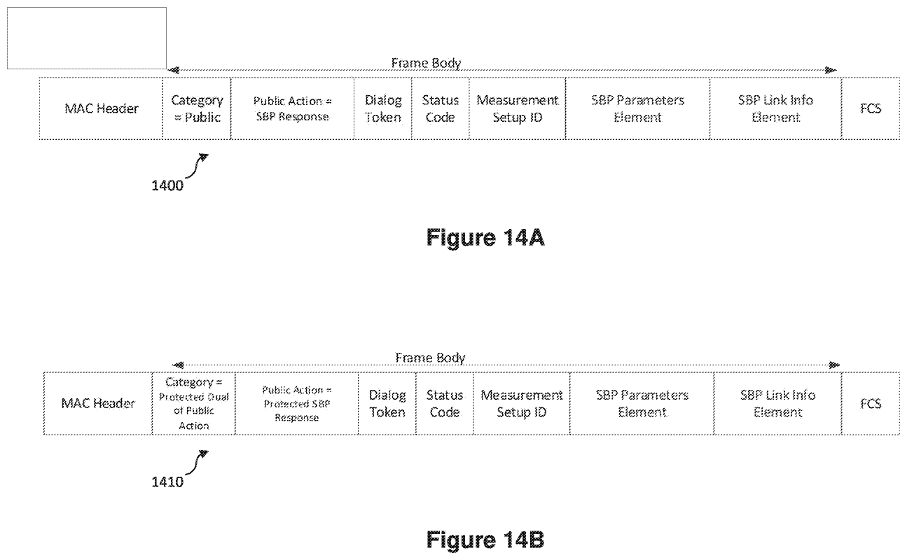

According to the first embodiment of the present disclosure, FIGS. 14A and 14B show example formats of an SBP Response frame 1400 and a Protected Response frame 1410, respectively. The SBP Response frame 1400 comprises a MAC Header (Frame Control field, Duration field, RA field and TA field), a Category field which is set to “Public”, a Public Action field which is set to “SBP Response”, a Dialog Token field, a Status Code field, a Measurement Setup ID field, an SBP Parameter Element field, an SBP Link Info Element field and a FCS field. The Protected SBP Response frame 1410 comprises a MAC Header (Frame Control field, Duration field, RA field and TA field), a Category field which is set to “Protected Dual of Public Action”, a Public Action field which is set to “Protected SBP Response”, a Dialog Token field, a Status Code field, a Measurement Setup ID field, an SBP Parameter Element field, an SBP Link Info Element field and a FCS field.

The Measurement Setup ID field is set to the Measurement Setup ID value that uniquely identifies an SBP procedure and all the measurement links corresponding to the SBP procedure. The Measurement Setup ID field is present in an SBP Response frame 1400, 1410 only if the status code field indicate “SUCCESS”.

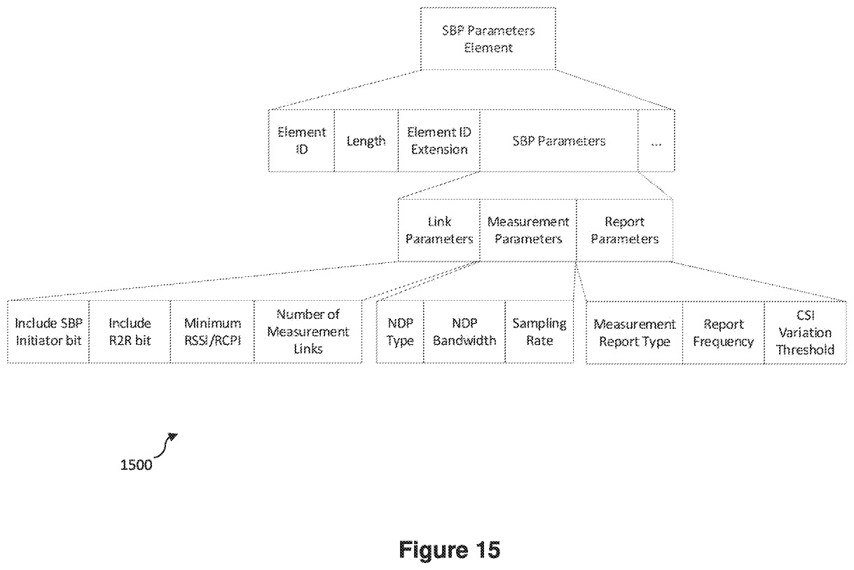

FIG. 15 shows an example format of the SBP Parameter Element field 1500 in the SBP Request/Response frames 1300, 1310, 1400, 1410 in FIGS. 13A-14B. The SBP Parameter Element field comprises an Element ID field, a Length field, an Element ID Extension field and an SBP Parameters field. The SBP Parameter field comprises a Link Parameters subfield, a Measurement Parameters subfield and a Report Parameter subfield which specify attributes related to the links to be measured, the measurement PPDUs and the SBP Reporting respectively.

The Link Parameter subfield comprises an Include SBP Initiator bit, an Include R2R bit, a Minimum RSSI/RCPI subfield and a Number of Measurement Links subfield. The Include SBP Initiator bit is set to 1 indicating a request to include the SBP Initiator as one of the sensing responder, therefore the measurement report on a link to which the SBP Initiator is attached will also be measured and included in the SBP report frame. The Include R2R bit is set to 1 to indicate that the R2R links may also be considered. The Minimum RSSI/RCPI subfield indicates an average RSSI or RCPI observed for the frames transmitted on a selected link is expected to be above the indicated level. The Number Of Links subfield indicates the number of links to be used for the sensing measurements.

The Measurement Parameters subfield comprises an NDP type subfield, an NDP Bandwidth subfield and a Sampling Rate subfield. The NDP type subfield indicate the NDP type or format (e.g., High Efficiency (HE), Extremely High Throughput (EHT) or Ranging, etc.) to be used to measure the channels. The NDP Bandwidth subfield indicates the channel bandwidth of the NDP to be used to measure the channels. The Sampling Rate subfield indicates the frequency of performing the measurements, that is, how often the sensing measurements are performed, in terms of Hz or number of measurements per second.

The Report Parameters subfield comprises a Measurement Report Type subfield, a Report Frequency subfield and a Channel State Information (CSI) Variation Threshold subfield. The Measurement Report Type subfield indicate the type of sensing measurement report to be used during the SBP Reporting procedure. The Report Frequency subfield indicates the frequency to transmit the SBP Report, that is, how often the SBP Reports are transmitted, in terms of Hz or number of transmissions per second. The CSI Variation Threshold subfield indicate a number between 0 to 1, which corresponds to a threshold value to be used to determine whether the change in measured CSI is significant enough for the AP to generate the SBP report.

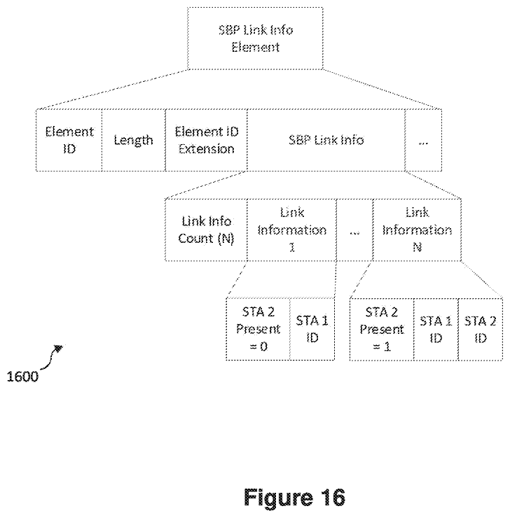

FIG. 16 shows an example format of the SBP Link Info Element field 1600 in the SBP Response frames 1400, 1410 in FIGS. 14A and 14B according to the embodiment. The SBP Link Info Element field comprises an Element ID field, a Length field, an Element ID Extension field and an SBP Link Info field. The SBP Link Info field comprises a Link Info Count (N) subfield and one or more Link Information field corresponding to one or more links. The Link Info Count (N) subfield indicates the number of links (Links Information subfields) present in the SBP Link Info field. Each Link Information subfield comprises a STA2 Present subfield, a STA1 ID subfield and a STA2 ID subfield (if the STA2 Present subfield is set to 1). For I2R or R2I links in which the SBP Responder itself is attached, the STA2 Present subfield is set to 0 and the STA1 ID subfield indicates the STA ID (e.g., MAC address or Associated Identifier (AID)) of the STA attached to the other end of the link. For R2R links, the STA2 Present subfield is set to 1 and the STA1 and STA2 ID subfields indicate the STA IDs (e.g., MAC addresses or AIDs) of the two STAs attached to the two ends of the R2R link. Alternatively, instead of STA IDs, a unique Link ID for each measurement link (assigned during sensing measurement setups for the SBP procedure) may be included in the Link Information subfield(s). The SBP Initiator will use the Link ID(s) to identify the measurement links in subsequent frames.

Regarding SBP Reporting, the sensing measurement results obtained in the WLAN sensing procedure resultant from an SBP request is reported to the SBP initiator by the SBP responder in a Protected SBP Report frame which is either constructed by the SBP responder (AP) itself (if the AP is also the sensing receiver), or constructed by adding the Link Information field (depicted in FIG. 16) and updating a Report Length field in each Sensing Measurement Report field obtained in the Sensing Measurement Report frame sent by the Sensing Responders on the link.

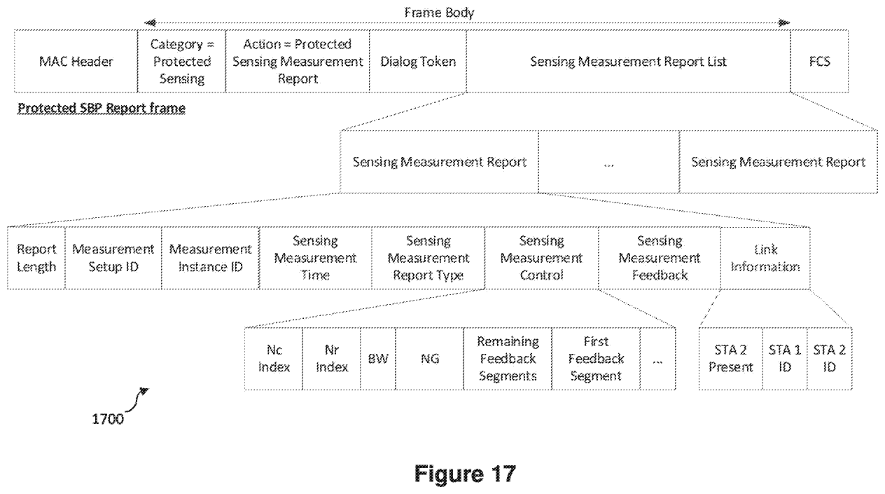

FIG. 17 shows an example format of an SBP Report frame 1700 according to the first embodiment of the present disclosure. The SBP Report frame 1700 comprises a MAC Header (Frame Control field, Duration field, RA field and TA field), a Category field which is set to “Protected Sensing”, an Action field which is set to “Protected SBP Report”, a Dialog Token field, a Sensing Measurement Report List field, and a FCS field. The Sensing Measurement Report List field comprises one or more Sensing Measurement Report field corresponding to one or more links. Each Sensing Measurement Report field comprises a Report Length field, a Measurement Setup ID field, a Measurement Instance ID field, a Sensing Measurement Time field, a Sensing Measurement Report Type field, a Sensing Measurement Control field, a Sensing Measurement Feedback field and a Link Information field. The Report Length field indicates the length of the Sensing Measurement Report field. If Link Information field is added, the Report Length field should also be updated accordingly. The Measurement Setup ID field indicates the Measurement Setup ID value corresponding to the SBP procedure. The Measurement Instance ID field identifies the measurement instance in which the sensing measurement is performed. The Sensing Measurement Time field indicates the measurement timestamp at which the measurement was performed by the Sensing Receiver (responder). The Sensing Measurement Control field comprises a Nc Index subfield, a Nr index subfield, a Bandwidth (BW) subfield, a NG (number of group) subfield, a Remaining Feedback Segments subfield and a First Feedback Segment subfield. The Sensing Measurement Feedback comprises the sensing measurement results for example, CSI or partial CSI, etc. The Link Information, which is described in FIG. 16, comprises a STA2 Present subfield, a STA1 ID subfield an a STA2 ID subfield (if the STA2 Present subfield is set to 1 to indicate a R2R link). The STA1 and STA2 ID subfields carry IDs (e.g., MAC Address or AID) of the sensing responders to identify the link corresponding to the sensing measurement report. Alternatively, instead of STA IDs, a unique Link ID for each measurement link may be assigned and included in the Link Information subfield(s).

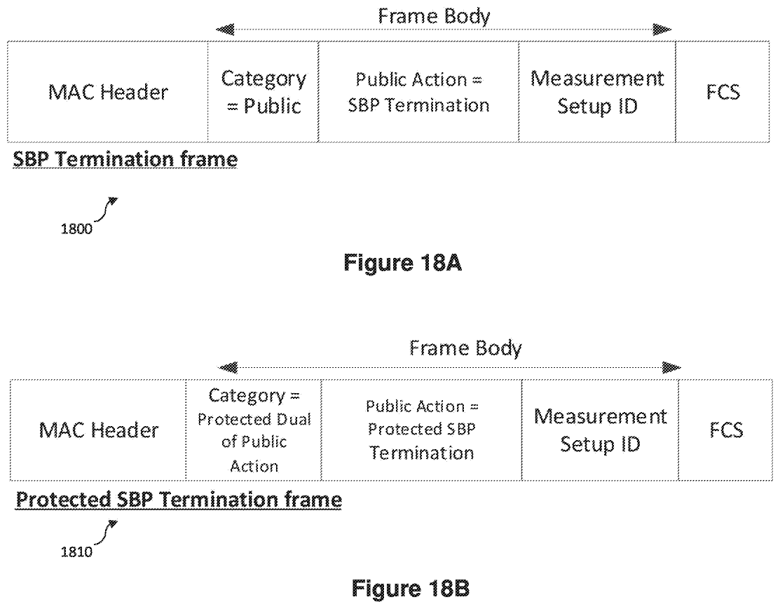

According to the first embodiment of the present disclosure, FIGS. 18A and 18B show example formats of an SBP Termination frame 1800 and a Protected SBP Termination frame 1810, respectively. The SBP Termination frame 1800 comprises a MAC Header (Frame Control field, Duration field, RA field and TA field), a Category field which is set to “Public”, a Public Action field which is set to “SBP Termination”, a Measurement Setup ID field and a FCS field. The Protected SBP Termination frame 1810 comprises a MAC Header (Frame Control field, Duration field, RA field and TA field), a Category field which is set to “Protected Dual of Public Action”, a Public Action field which is set to “Protected SBP Termination”, a Measurement Setup ID field and a FCS field. The Measurement Setup ID field is set to the Measurement Setup ID value assigned by the SBP responder (AP) corresponding to the SBP procedure to be terminated.

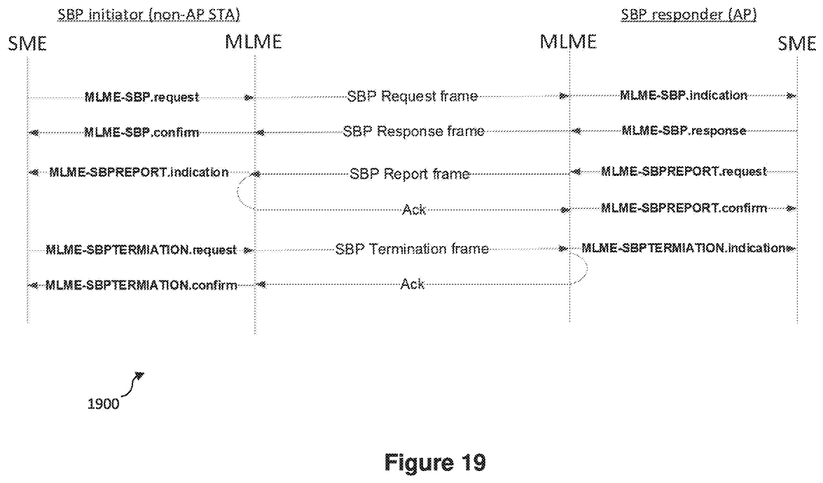

FIG. 19 shows a flowchart 1900 illustrating communication between an SBP Initiator (non-AP STA) and an SBP Responder (AP), such as communications between Station management entities (SMEs) and MAC Sublayer Management Entities (MLMEs) of the SBP Initiator and the SBP Responder, for sensing by proxy according to the first embodiment of the present disclosure. The MLME-SBP.request primitive is issued by the MAC sublayer by the SME of the SBP Initiator to requests for a transmission of an SBP Request frame to a peer STA (the SBP Responder). Upon receipt of this primitive, the MLME of the SBP Initiator constructs an SBP Request frame and causes it to be transmitted to the peer STA's (SBP Responder) MAC address. The MLME-SBP.request primitive and its primitive parameters are illustrated as follows.

MLE-SBP.request(

PeerSTAAddress,
SBPParameters
)

Table 1 shows details of primitive parameters included in a MLME_SBP_request primitive.

| Name | Type | Valid range | Description |
|---|---|---|---|
| PeerSTAAddress | MAC Address | Any valid | Specifies the |
| | | individual | address of the |
| | | MAC address | peer MAC entity |
| | | | with which the |
| | | | SBP procedure is |
| | | | to be performed. |
| SBPParameters | SBP | As defined in the | Specifies the |
| | Parameters | SBP Parameters | parameters for |
| | Element | Element | the SBP Setup. |

The MLME-SBP.indication primitive is issued by the MAC sublayer to the SME of the SBP Responder to inform the reception of the SBP Request frame from a peer STA (SBP Initiator). Upon receipt of this primitive, the SME initiates an SBP procedure on behalf of the peer STA. The MLME-SBP_inidication primitive and its primitive parameters are illustrated as follows.

MLME-SBP.indication (

PeerSTAAddress,
SBPParameters
)

Table 2 shows details of primitive parameters included in a MLME_SBP.indication primitive.

| Name | Type | Valid range | Description |
|---|---|---|---|
| PeerSTAAddress | MAC Address | Any valid | Specifies the |
| | | individual | address of the |
| | | MAC address | peer MAC entity |
| | | | from which the |
| | | | SBP Request |
| | | | frame is received. |
| SBPParameters | SBP | As defined in the | Specifies the |
| | Parameters | SBP Parameters | parameters for |
| | Element | Element | the SBP Setup. |

The MLME-SBP.response primitive is issued to the MAC sublayer by the SME of the SBP Responder in response to a MLME-SBP.indication and request for a transmission of an SBP Response frame to the peer STA (SBP Initiator). On receipt of the primitive, the MLME of the SBP Responder constructs an SBP Response frame and causes it to be transmitted to the peer STA's MAC address. The MLME-SBP response primitive and its primitive parameters are illustrated as follows.

MLME-SBP.response (

PeerSTAAddress,
StatusCode,
SBPParameters,
MeasurementSetupID,
SBPLinkInfo
)

Table 3 shows details of primitive parameters included in a MLME_SBP_response primitive.

| Name | Type | Valid range | Description |
|---|---|---|---|
| PeerSTAAddress | MAC Address | Any valid individual | Specifies the |
| | | MAC address | address of the peer |
| | | | MAC entity with |
| | | | which the SBP |
| | | | procedure is to be |
| | | | performed. |
| StatusCode | Enumerated value | As defined in the | Indicates the status |
| | | Status Code field. | of the SBP Request |
| SBPLinkInfo | SBP Link Info | As defined in the | Identifies the link(s) |
| | Element | SBP Link Info | corresponding to |
| | | Element | the SBP sensing |
| | | | measurements. |
| MeasurementSetupID | Integer | Any valid ID | Specifies the |
| | | | Measurement |
| | | | Setup ID assigned |
| | | | for the SBP setup. |
| SBPParameters | SBP Parameters | As defined in the | Specifies the |
| | Element | SBP Parameters | parameters for the |
| | | Element | SBP Setup. |

The MLME-SBP.confirm primitive is issued to the MAC sublayer to the SME of the SBP Initiator to inform the results of the SBP Request upon receipt of the SBP Response from the peer STA (SBP Responder). THE MLME-SBP confirm primitive and its primitive parameters are illustrated as follows.

MLME-SBP.confirm (

PeerSTAAddress,
StatusCode,
SBPParameters,
MeasurementSetupID,
SBPLinkInfo
)

Table 4 shows details of primitive parameters included in a MLME-SBP.confirm primitive.

| Name | Type | Valid range | Description |
|---|---|---|---|
| PeerSTAAddress | MAC Address | Any valid individual | Specifies the |
| | | MAC address | address of the peer |
| | | | MAC entity from |
| | | | which the SBP |
| | | | Response frame is |
| | | | received. |
| StatusCode | Enumerated value | As defined in the | Indicates the status |
| | | Status Code field. | of the SBP Request |
| SBPLinkInfo | SBP Link Info | As defined in the | Identifies the link |
| | Element | SBP Link Info | corresponding to |
| | | Element | the SBP sensing |
| | | | measurements. |
| MeasurementSetupID | Integer | Any valid ID | Specifies the |
| | | | Measurement |
| | | | Setup ID assigned |
| | | | for the SBP setup. |
| SBPParameters | SBP Parameters | As defined in the | Specifies the |
| | Element | SBP Parameters | parameters for the |
| | | Element | SBP Setup. |

The MLME-SBPREPORT.request primitive is issued to the MAC sublayer by the SME of the SBP Responder to requests a transmission of an SBP Report frame to the Peer STA (SBP Initiator). Upon receipt of the primitive, the MLME of the SBP Responder constructs an SBP Report frame and causes it to be transmitted to the peer STA's MAC address. The MLME-SBPREPORT.request primitive and its primitive parameters are illustrated as follows.

MLME-SBPREPORT.request (

PeerSTAAddress,
SensingMeasurementReportList
)

Table 5 shows details of primitive parameters included in a MLME-SBPREPORT.request primitive.

| Name | Type | Valid range | Description |
|---|---|---|---|
| PeerSTAAddress | MAC Address | Any valid | Specifies the |
| | | individual | address of the |
| | | MAC address | peer MAC entity |
| | | | to which the SBP |
| | | | Report frame is |
| | | | to be |
| | | | transmitted. |
| SensingMeasurementReportList | Sensing | As defined in | Carries one or |
| | Measurement | the SBP | more Sensing |
| | Report List | Report frame | Measurement |
| | | | Reports |
| | | | corresponding to |
| | | | the SBP |
| | | | procedure |

The MLME-SBRREPORT.indication primitive is issued by the MAC sublayer to the SME of the SBP Initiator to inform the receipt of SBP Report frame from the peer STA (SBP Responder). The MLME-SBRREPORT.indication primitive and its primitive parameters are illustrated as follows.

MLME-SBPREPORT.indication (

PeerSTAAddress,
SensingMeasurementReportList
)

Table 6 shows details of primitive parameters included in a MLME-SBPREPORT.request primitive.

| Name | Type | Valid range | Description |
|---|---|---|---|
| PeerSTAAddress | MAC Address | Any valid | Specifies the |
| | | individual | address of the |
| | | MAC address | peer MAC entity |
| | | | from which the |
| | | | SBP Report |
| | | | frame is |
| | | | received. |
| SensingMeasurementReportList | Sensing | As defined in | Carries one or |
| | Measurement | the SBP | more Sensing |
| | Report List | Report frame | Measurement |
| | | | Reports |
| | | | corresponding to |
| | | | the SBP |
| | | | procedure |

The MLME-SBPREPORT.confirm primitive is issued by the MAC sublayer to the SME of SBP Responder to inform the result of the request for the transmission of the SBP Report frame. The MLME-SBPREPORT.confirm primitive and its primitive parameters are illustrated as follows.

MLME-SBPREPORT.confirm (

PeerSTAAddress,
StatusCode,
)

Table 7 shows details of primitive parameters included in a MLME-SBPREPORT.confirm primitive.

| Name | Type | Valid range | Description |
|---|---|---|---|
| PeerSTAAddress | MAC Address | Any valid | Specifies the |
| | | individual MAC | address of the |
| | | address | peer MAC entity |
| | | | to which the SBP |
| | | | Report frame is |
| | | | transmitted. |
| StatusCode | Enumerated | As defined in | Indicates the |
| | value | the Status | status of the |
| | | Code field. | request to |
| | | | transmit the SBP |
| | | | Report frame. |

The MLME-SBPTERMINATION.request primitive is issued to the MAC sublayer by the SME to requests the transmission of an SBP Termination frame to a peer STA. On receipt of this primitive, the MLME constructs an SBP Termination frame and causes it to be transmitted to the peer MAC address.

MLME-SBPTERMINATION.request (

PeerSTAAddress,
)

Table 8 shows details of primitive parameters included in a MLME-SBPTERMINATION.request primitive.

| Name | Type | Valid range | Description |
|---|---|---|---|
| PeerSTAAddress | MAC Address | Any valid | Specifies the |
| | | individual MAC | address of the |
| | | address | peer MAC entity |
| | | | to which the SBP |
| | | | Termination |
| | | | frame is |
| | | | transmitted. |

The MLME-SBPTERMINATION.indication primitive is issued by the MAC sublayer to the SME to inform the reception of an SBP Termination frame from a peer STA.

MLME-SBPTERMINATION.indication (

PeerSTAAddress,
)

Table 9 shows details of primitive parameters included in a MLME-SBPTERMINATION. indication primitive.

| Name | Type | Valid range | Description |
|---|---|---|---|
| PeerSTAAddress | MAC | Any valid | Specifies the address |
| | Address | individual | of the peer MAC |
| | | MAC address | entity from which |
| | | | the SBP Termination |
| | | | frame is received. |

The MLME-SBPTERMINATION.confirm primitive is issued by the MAC sublayer to the SME to inform the result of the request to transmit an SBP Termination frame.

MLME-SBPTERMINATION.confirm (

PeerSTAAddress,
StatusCode,
)

Table 10 shows details of primitive parameters included in a MLME-SBPTERMINATION. confirm primitive.

| Name | Type | Valid range | Description |
|---|---|---|---|
| PeerSTAAddress | MAC Address | Any valid | Specifies the |
| | | individual MAC | address of the |
| | | address | peer MAC entity |
| | | | to which the SBP |
| | | | Termination |
| | | | frame is |
| | | | transmitted. |
| StatusCode | Enumerated | As defined in | Indicates the |
| | value | the Status | status of the |
| | | Code field. | request to |
| | | | transmit the SBP |
| | | | Termination |
| | | | frame. |

Although in FIG. 19, the SBP Termination frame is transmitted by the SBP Initiator it could be transmitted by the SBP Responder as well, in which case the direction of the corresponding MLME primitives will be reversed.

In the following paragraphs, a second embodiment of the present disclosure for sensing by proxy procedure, where a non-AP STA indicates a condition and a target STA(s) or link(s) information for an AP to select one or more other non-AP STAs or links, is described.

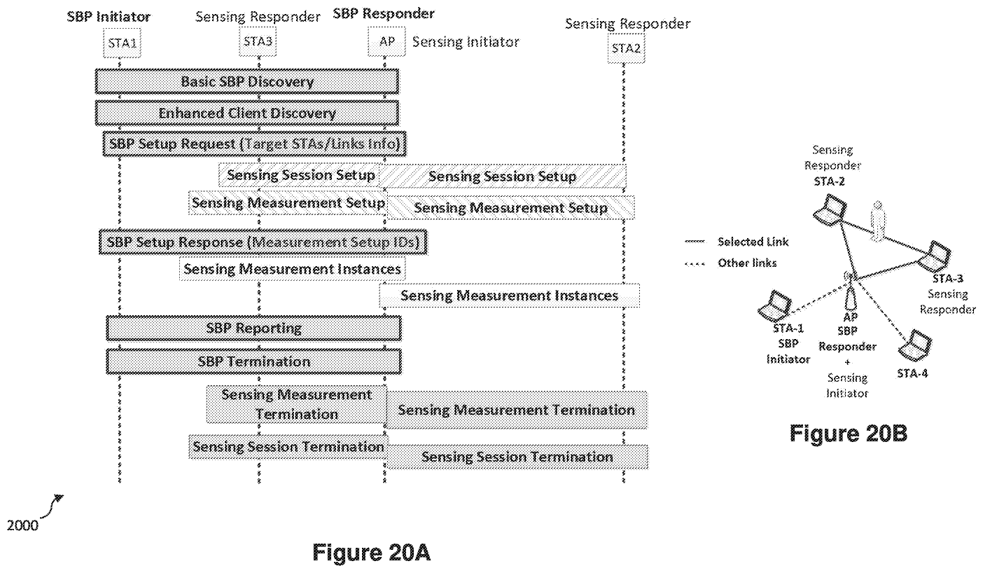

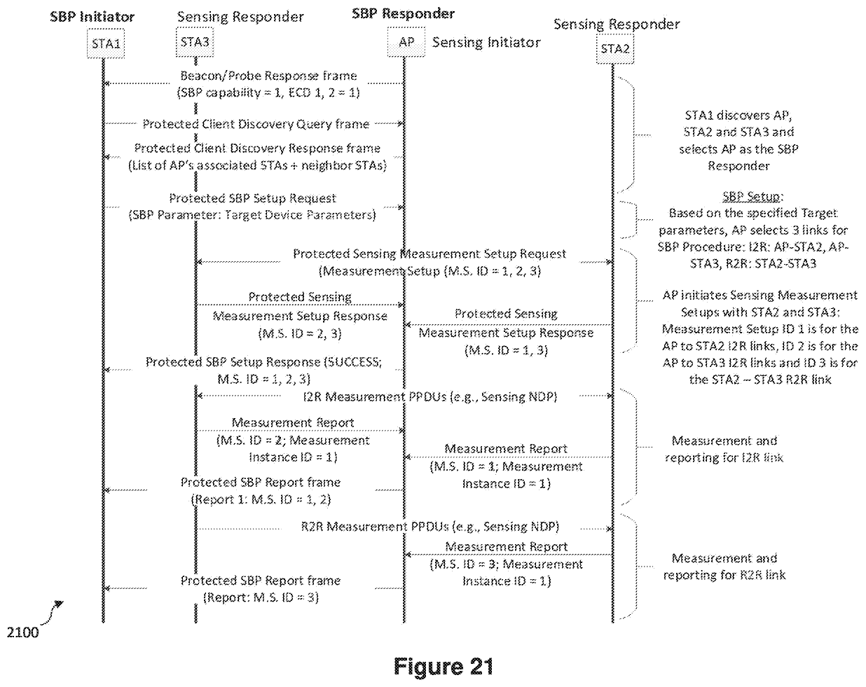

FIG. 20A shows a flowchart 2000 illustrating an overview of a sensing by proxy procedure between an AP and three non-AP STAs (STA1, STA2, STA3) according to the second embodiment of the present disclosure. FIG. 21 shows a flowchart 2100 illustrating a detailed procedural flow of the sensing by proxy procedure between the AP and the three non-AP STAs in FIG. 20A. Firstly, the AP advertises its capability to support enhanced client discovery and basic information about associated non-AP STAs (e.g., count/number of associated STAs etc.) using a Beacon/Probe Response frame. The STA1 may perform a basic SBP discovery and discover an AP's support of the SBP function. The STA1 may then select the AP as its SBP responder.

STA1 (SBP Initiator) may then initiate an enhanced client discovery procedure by transmitting a protected client discovery query frame to request the AP (SBP Responder) to provide a list of non-AP STAs (associated non-AP STAs and optionally unassociated non-AP STAs). The AP then transmits a protected Client Discovery Response frame with the requested list of non-AP STAs and, optionally, their respective neighboring STAs, and the enhanced client discovery procedure ends.

It is noted that the SBP initiator (STA1) may either be associated with the AP (SBP Responder) in which case it is assumed to have already completed the usual authentication/association procedure with the AP as well as setting up of security association (SA), for example, through a 4-way handshake prior to the initiation of the SBP Request; Or, it may be unassociated with the AP in which case it is assumed to have already completed the setting up of security associated with the AP, for example, through a pre-association security negotiation (PASN) through a 3-way handshake prior to the initiation of the SBP request.

STA1 discovers AP, STA2 and STA3 through the discovery procedure and selects the AP as the SBP responder. It then initiates an SBP procedure and requests the AP to be a proxy sensing initiator on its behalf by transmitting a Protected SBP Request frame carrying link/measurement parameters and information relating to SBP links and measurement attributes such as Minimum RSSI/RCPI and number of measurement links. Unlike the SBP procedure described in the first embodiment, in this second embodiment, the SBP Request frame also comprises information of target device parameters such as location, coverage information and STA ID of one or more particular target sensing responder(s). Based on the link/measurement parameters and target device parameters, the AP then decides 3 STAs/links that are more relevant for the sensing measurements (in this case, an I2R link attached to STA2, an I2R link attached to STA3 as well as STA2-to-STA3 R2R link) based on the parameters and information of the target sensing responder(s), as shown in FIG. 20B, and initiate a sensing session setup and a sensing measurement setup with the selected STAs (STA2, STA3) by transmitting a Protected Sensing Measurement Setup Request frame to them.

In this second embodiment, a unique measurement setup ID (M.S. ID) is assigned to each measurement link for the SBP procedure. For example, the AP-to-STA3 I2R link is assigned to M.S. ID “1”; the AP-to-STA2 link is assigned to M.S. ID “2”; and the STA2-to-STA3 R2R link is assigned to MS. ID “3”. STA2, STA3 (sensing responders) receiving the Protected Sensing Measurement Setup Request frame then transmits a Protected Sensing Measurement Setup Response frame back to the AP (SBP Responder or proxy sensing initiator) indicating a successful sensing measurement setup.

The AP then transmits a Protected SBP Response frame to indicate a successful setup with its sensing responders and the measurement setup IDs selected for the SBP procedure and assigned to the measurement links back to the SBP Initiator (STA1) to complete the SBP setup.

Subsequently, the AP perform sensing measurement instances with STA2 and STA3 by first transmitting I2R Measurement PPDUs (e.g., Sensing NDP) to STA2 and STA3. STA2 and STA3, in response, measures the respective channels based upon receiving the I2R Measurement PPDUs, and if requested, transmit their measurement reports. The measurement reports comprise their respective measurement setup IDs “1” and “2”. After collecting the measurement reports on its links, the AP then consolidate the measurement reports and transmits a Protected SBP Report frame comprising the measurement reports of its I2R links with STA2 and STA3 to STA1. The measurement setup IDs are included in the measurement reports in the SBP Report frame for identifying the measurement links, respectively. Alternatively or additionally, R2R measurement and reporting for R2R link may also be carried out during the same measurement instance (Measurement Instance ID 1). In this case, STA2 transmits a R2R Measurement PPDUs (e.g., Sensing NDP) to STA3, and STA3, in response, transmits a measurement report to the AP. The measurement report comprises its measurement setup ID “3”. Upon receipt of the measurement reports, the AP then transmits a Protected SBP Report frame comprising the measurement report of the R2R link between STA2 and STA3 to STA1. The measurement setup IDs are included in the measurement reports in the SBP Report frame for identifying the measurement links, respectively.

Alternatively, as illustrated in FIG. 20A, the AP may perform measurements on different links/STAs at different measurement instances (different Measurement Instance ID but same Measurement Setup ID), for example, perform a sensing measurement with STA3 at first measurement instance under Measurement Instance ID “1” and then a sensing measurement with STA2 at second measurement instance under Measurement Instance ID “2”. The AP then transmits an SBP Report frame comprising the measurement reports of its I2R links with STA2 and STA3 received in different measurement instances to STA1. The measurement setup IDs are included in the measurement reports in the SBP Report frame for identifying the I2R and R2R measurement links, respectively.

Finally, after SBP procedure, STA1 may initiate an SBP procedure termination by transmitting an SBP Termination frame (not shown) to the AP. The AP then perform sensing measurement termination and sensing session termination with STA2 and STA3 for the sensing measurement setup IDs corresponding to the SBP procedure.

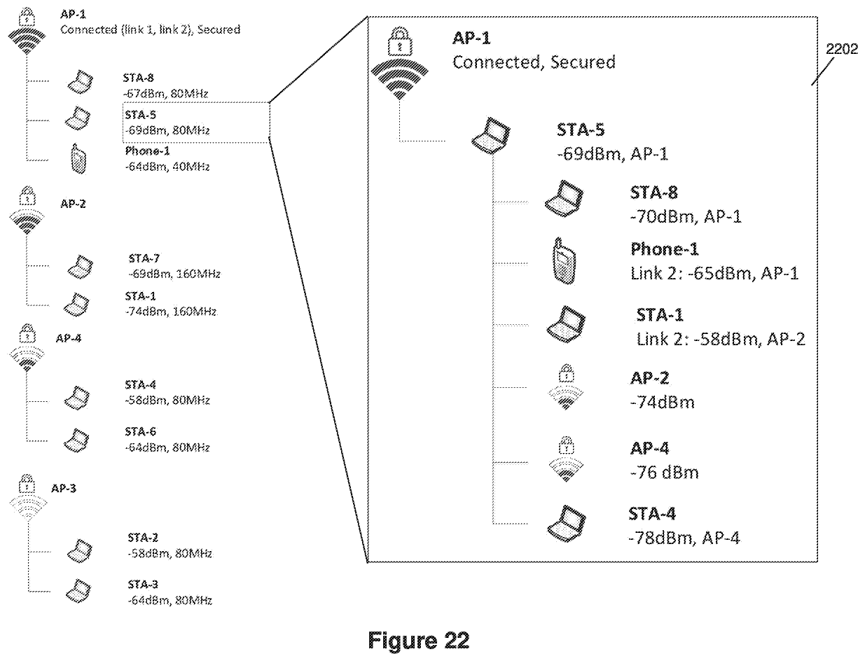

FIG. 22 shows an example visualization of enhanced client discovery results. The enhanced client discovery results match the links between devices located in the floor plan as illustrated in FIG. 5. Such visualization may be displayed on a screen of a laptop, a smartphone or any electronic device. In this example, an SBP initiator (STA8) may perform level 1 client discovery and only a list of APs/AP MLDs (in this case, four different APs (AP1, AP2, AP3 and AP4) is displayed. Each AP then sends their discovery results comprising a list of STAs associated with the AP with their basic information to the SBP initiator. The results may be sorted in descending order according to their link quality. Optionally, a list of unassociated STAs (and/or MLDs) that the AP is aware of is also provided by the AP. In this example, AP1 provides information of STA8, STA5 and Phone1; AP2 provides information of STA7 and STA1; AP4 provides information of STA4 and STA6; and AP3 provides information of STA2 and STA3. The SBP initiator may, additionally or alternatively, perform level 2 client discovery. This level 2 client discovery may be trigger upon selecting on a particular STA or non-AP MLD. In this example, the STA-5 is selected and the SBP initiator perform level 2 client discovery with AP1 for STA-5. A client discovery query frame comprising STA-5′ ID (e.g., MAC Address) is transmitted to AP1. Accordingly, AP1 provides information of STA-5 as well as its neighboring APs, STAs (in this case, STA5, STA8 (SBP initiator itself), Phone1, STA1, AP2, AP4 and STA4) located within the radio range of STA-5, as illustrated in block 2202. The results can then be used to select the sensing responders for SBP procedure measurement.

As part of the Enhanced Client Discovery, the SBP Initiator can also discover the location of the APs (in addition to that of the non-AP STAs). The location information may be obtained via GPS (when outdoors), or via Fine Time Measurements and/or Ranging (when indoors) etc. The location information of the AP (along with other information such as supported capabilities etc.) may be used by the SBP Initiator to select the right AP to act as the SBP Responder. When the STA Info field in a Client Discovery Response frame carries information of DMG (directional multi-gigabit i.e., 802.11ad) or EDMG (enhanced directional multi-gigabit i.e., 802.11ay) STAs, the STA Info field may also carry a Sector Select subfield that contains the value of the Sector ID subfield of the SSW field within the frame that was received with best quality in the immediately preceding sector sweep. The Sector ID subfield indicates the sector number through which the frame containing this SSW field is transmitted. When choosing a Sensing Responder STA among DMG/EDMG STAs, the AP may use the consider the information of the sector number.

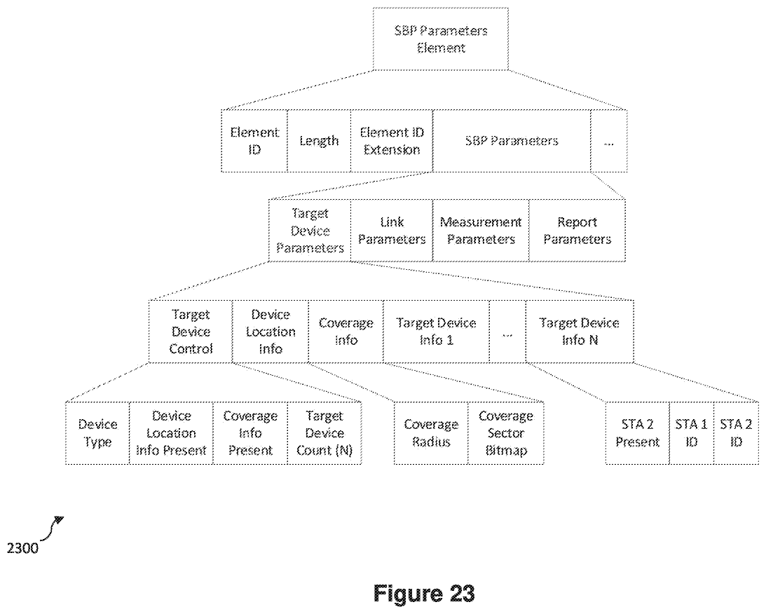

FIG. 23 shows an example format of a SBP Parameter Element field of an SBP Request frame according to the second embodiment of the present disclosure. The SBP Parameter Element field 2300 comprises an Element ID field, a Length field, an Element ID Extension field and an SBP Parameters field. Unlike the SBP Parameter Element field described in FIG. 15 for the first embodiment, the SBP Parameter field comprises an additional Target Device Parameter subfield, a Link Parameters subfield, a Measurement Parameters subfield and a Report Parameter subfield which specify attributes related to the target STAs/links, the links to be measured, the measurement PPDUs and the SBP Reporting respectively.

The Link Parameter subfield, the Measurement Parameters subfield and Report Parameters subfield may be the same as that described in FIG. 15. The Target Device Parameters subfield comprises a Target Device Control field, a Device Location Info field, a Coverage Info field and one or more Target Device Info fields. The Target Device Control field comprises a Device Type subfield, a Device Location Info Present subfield, a Coverage Info Present subfield and a Target Device Count (N) subfield. The Device Type subfield specifies the device type restrictions for the sensing responder.

Table 11 shows various device types corresponding to the Device Type subfield values.

| Device Type subfield value | Meaning |
|---|---|
| 0 | Include all types |
| 1 | Only non-mobile devices |
| 2 | Desktop PCs |
| 3 | Laptops |
| 4 | Smartphones |
| 5 | IOT |

The Device Location Info Present and the Coverage Info Present subfields indicates the presence of the corresponding fields in the Target Device Parameters subfield. The Target Device Count (N) subfield indicates the number of Target Device Info field(s) in the Target Device Parameters subfield.

The Device Location Info field specifies the location of the device which is then used to as a center to determine a coverage area or radio range extended from the location. The Coverage Info field comprises a Coverage Radius subfield and a Coverage Sector Bitmap subfield. The Coverage Radius subfield specifies the radius (e.g., as presented by RSSI/RCPI level (dBm) or as distance (m)) of the coverage area with device location specified in the Device Location Info field. The Coverage Sector Bitmap subfield indicates a segment or an area relative to the device's location.

The Device Location Info field carries information about the location in which the target STAs should be located. For example, the field may carry the Device Location Information Body field as described in 9.4.1.56 of 802.11-2020. A Device Location Information Body field includes the location configuration information (LCI), which contains latitude, longitude, and altitude information. Together with the Coverage Info field, the SBP Initiator can specify the coverage area (with the located indicated in the Device Location Info field) in which it requests the AP (SBP Responder) to select the target sensing responders. If the Device Location Info field is not present, but the Coverage info field is present, the SBP Responder (AP)'s location will be considered the center of the target coverage area.

Table 12 shows various sectors indicated by the Coverage Sector Bitmap bits.

| Coverage Sector Bitmap bit | Indicated sector |
|---|---|
| 0 | North |
| 1 | South |
| 2 | East |
| 3 | West |

Each Target Device Info field in the Target Device Parameters subfield specifies a target link and comprises a STA2 Present subfield, a STA1 ID subfield and a STA2 ID subfield. For I2R or R2I links, the STA2 Present subfield is set to 0 and the STA1 ID subfield indicates the STA ID (e.g., MAC address, Associated Identifier (AID) or Unassociated ID (UID)) of the STA attached to the link, while the SBP Responder is understood to be attached to the other end of the link. For R2R links, the STA2 Present subfield is set to 1 and the STA1 and STA2 ID subfields indicate the STA IDs (e.g., MAC addresses or AIDs) of the two STAs attached to the R2R link. Alternatively, instead of STA IDs, a unique Link ID for each measurement link may be assigned and included in the Link Information subfield(s).

Although it is not shown in the figure, other information regarding the Target Device may also be included in the Target Device Parameters fields, such as Device name, PHY version (HT/VHT/HE/EHT etc.), supported capabilities (WLAN Sensing supported, Fine Time Measurement (FTM) supported etc.).

According to the second embodiment of the present disclosure, the SBP Initiator provides target device parameters specified in Target Device Parameters subfield frame in addition to the link/measurement parameters of the SBP Parameter Element field in the SBP Request to the SBP Responder (AP), and the SBP Responder (AP) uses the provided target device parameters and the link parameters to select the STAs/links to be used for the SBP sensing measurement. For example, if the Device Location Info field and Coverage Info field are included, the AP may select STAs that are located within the specified sector of the Coverage area and that satisfy the link parameters (e.g., minimum RSSI/RCPI). Additionally or alternatively, if the Target Device Info fields are included, the AP directly select the indicated STAs that satisfy the other parameters such as link parameters. The SBP Responder (AP) then proceeds to act as a Sensing Initiator and performs sensing session setup and sensing measurement setup with the selected STAs (sensing responders), using a unique measurement setup ID for each measurement link.

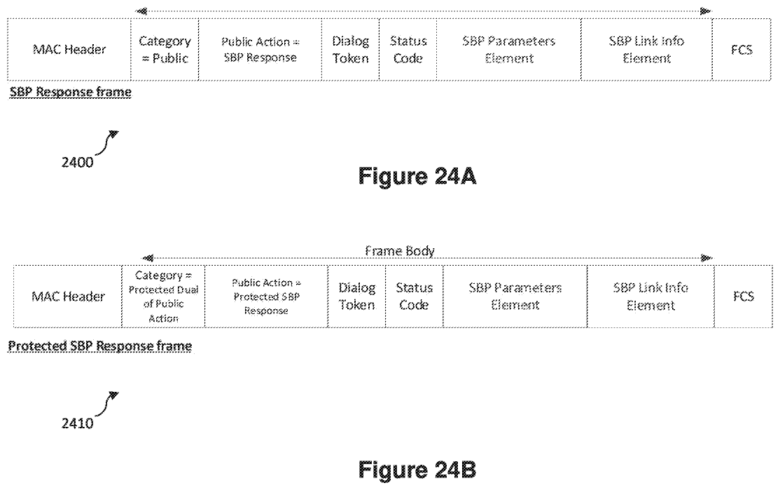

FIGS. 24A and 24B show example formats of an SBP Response frame 2400 and a Protected Response frame 2410, respectively, according to the second embodiment of the present disclosure. The SBP Response frame 2400 comprises a MAC Header (Frame Control field, Duration field, RA field and TA field), a Category field which is set to “Public”, a Public Action field which is set to “SBP Response”, a Dialog Token field, a Status Code field, an SBP Parameter Element field, an SBP Link Info Element field and a FCS field. The Protected SBP Response frame 2410 comprises a MAC Header (Frame Control field, Duration field, RA field and TA field), a Category field which is set to “Protected Dual of Public Action”, a Public Action field which is set to “Protected SBP Response”, a Dialog Token field, a Status Code field, an SBP Parameter Element field, an SBP Link Info Element field and a FCS field. It is noted that, as different measurement links are assigned to different measurement setup ID for the SBP procedure according to the second embodiment, the Measurement Setup ID is included in the SBP Link Element field of the SBP Response frames 2400, 2410, which is different from the SBP Response frames 1400, 1410 described in FIGS. 14A and 14B. Alternatively, it is possible that a Measurement Setup ID field is also carried in the SBP Response frame itself, and a unique measurement setup ID is assigned to represent the SBP procedure.

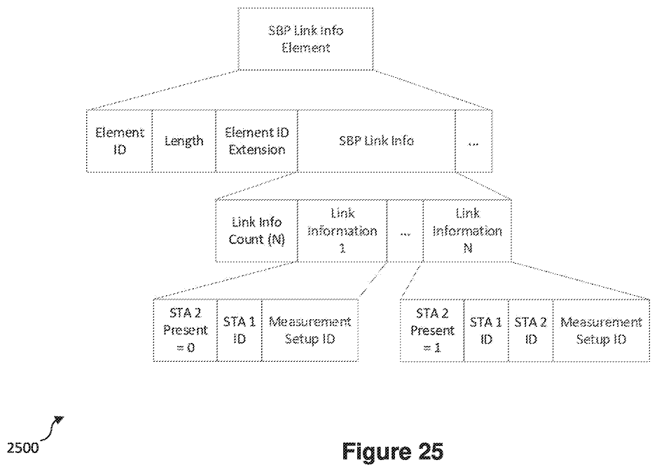

FIG. 25 shows an example format of the SBP Link Info Element field 2500 in the SBP Response frames 2400, 2410 in FIGS. 24A and 24B according to the embodiment. The SBP Link Info Element field comprises an Element ID field, a Length field, an Element ID Extension field and an SBP Link Info field. The SBP Link Info field comprises a Link Info Count (N) subfield and one or more Link Information field corresponding to one or more links. The Link Info Count (N) subfield indicates the number of links (Links Information subfields) present in the SBP Link Info field. Each Link Information subfield comprises a STA2 Present subfield, a STA1 ID subfield, a STA2 ID subfield (if the STA2 Present subfield is set to 1) and a Measurement Setup ID subfield. For I2R or R2I links, the STA2 Present subfield is set to 0 and the STA1 ID subfield indicates the STA ID (e.g., MAC address, AID or UID) of the STA attached to the link. For R2R links, the STA2 Present subfield is set to 1 and the STA1 and STA2 ID subfields indicate the STA IDs (e.g., MAC addresses, AIDs, or UID) of the two STAs attached to the R2R link. A unique Link ID for each measurement link is assigned and included in the Measurement Setup ID subfield of the Link Information subfield(s).

If the setups are successful, the AP proceeds to perform sensing measurement instances on the selected links based on the attributes indicated in the SBP Request and collects the sensing measurement reports from the Sensing Responders if applicable.

Regarding SBP Reporting, the sensing measurement results obtained in the WLAN sensing procedure resultant from an SBP request is reported to the SBP initiator by the SBP responder in a Protected SBP Report frame which is either constructed by the SBP responder (AP) itself (if the AP is also the sensing receiver), or constructed by adding the Link Information field (depicted in FIG. 16) and updating a Report Length field in each Sensing Measurement Report field obtained in the Sensing Measurement Report frame sent by the Sensing Responders on the link.

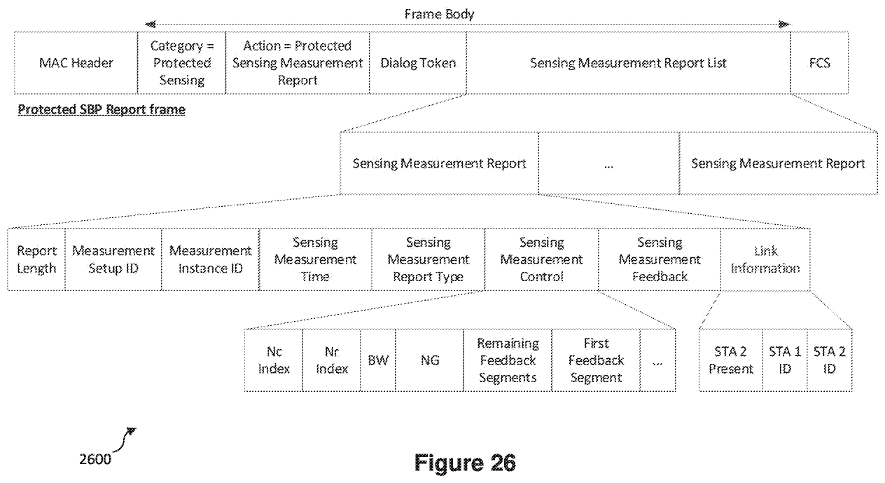

FIG. 26 shows an example format of an SBP Report frame 2600 according to the second embodiment of the present disclosure. The SBP Report frame 2600 comprises a MAC Header (Frame Control field, Duration field, RA field and TA field), a Category field which is set to “Protected Sensing”, an Action field which is set to “Protected SBP Report”, a Dialog Token field, a Sensing Measurement Report List field, and a FCS field. The Sensing Measurement Report List field comprises one or more Sensing Measurement Report field corresponding to one or more links. Each Sensing Measurement Report field comprises a Report Length field, a Measurement Setup ID field, a Measurement Instance ID field, A Sensing Measurement Time field, a Sensing Measurement Report Type field, a Sensing Measurement Control field, a Sensing Measurement Feedback field and a Link Information field. The Report Length field indicates the length of the Sensing Measurement Report field. If Link Information field is added, the Report Length field should also be updated accordingly. The Measurement Setup ID field indicates the Measurement Setup ID value corresponding to the measurement setup assigned and initiated by the AP. The Measurement Setup ID uniquely identifies the link corresponding to the sensing measurement report from other sensing measurement reports. The Measurement Instance ID field identifies the measurement instance in which the sensing measurement is performed. The Sensing Measurement Time field indicates the measurement timestamp at which the measurement was performed by the Sensing Receiver (responder). The Sensing Measurement Control field comprises a Nc Index subfield, a Nr index subfield, a Bandwidth (BW) subfield, a NG (number of group) subfield, a Remaining Feedback Segments subfield and a First Feedback Segment subfield. The Sensing Measurement Feedback comprises the sensing measurement results for example, CSI or partial CSI, etc. The Link Information, which is described in FIG. 25, comprises a STA2 Present subfield, a STA1 ID subfield an a STA2 ID subfield (if the STA2 Present subfield is set to 1 to indicate a R2R link). The STA1 and STA2 ID subfields carry IDs (e.g., MAC Address, AID or UID) of the sensing responders to identify the link corresponding to the sensing measurement report. Alternatively, instead of STA IDs, a unique Link ID for each measurement link may be assigned and included in the Link Information subfield(s). In this embodiment, since unique Measurement Setup IDs are assigned to identify each measurement link, the Link Information field may be omitted. It is also possible that in this case, instead of using the Protected SBP Report frame, the SBP Responder may directly forward the Protected Sensing Measurement Report frames received from the STAs (with correct modifications to the MAC headers as necessary), or generated by itself, to the SBP Initiator, that is to say, the Sensing Measurement Report frames are also used as SBP Report frames.

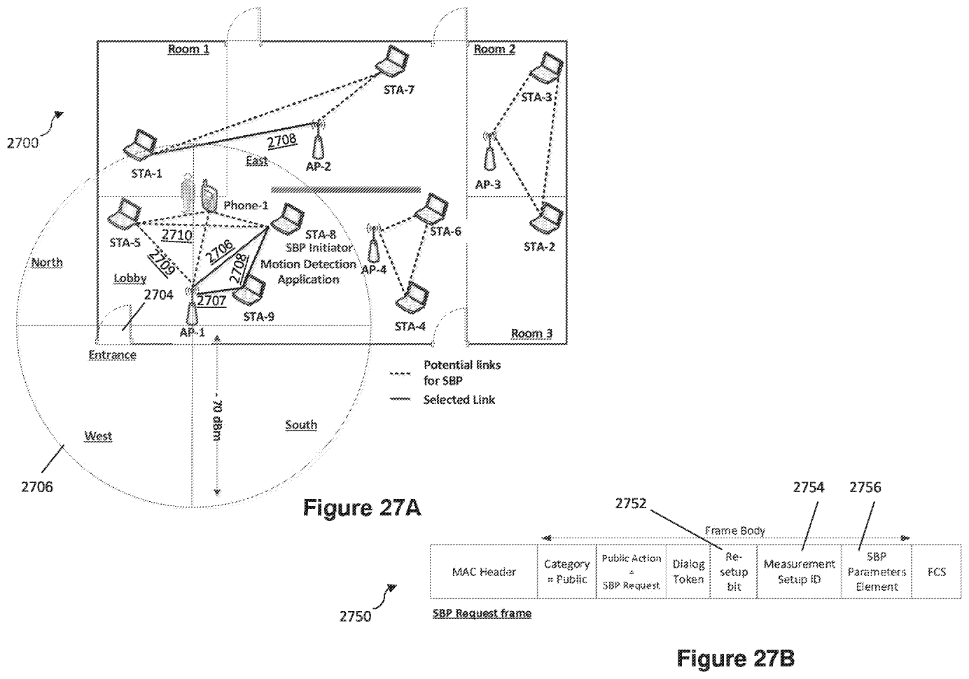

FIG. 27A shows a schematic diagram 2700 showing a floor plan and devices located therein together with two example implementations of a sensing by proxy procedure according to the second embodiment of the present disclosure. In one example, a motion detection sensing application is running on the SBP Initiator (STA8) to detect any human motions at the office entrance/lobby area 2704. SBP Initiator performs Basic and Enhanced Client Discovery and selects AP1 and AP2 as its two SBP Responders, e.g., based on their capabilities (e.g., SBP support) and location etc., as well as their associated STAs' capabilities and location, etc. In this example, the SBP Initiator includes the following Target Device parameters and Link parameters as its target selection criteria to AP1:
Device Type=“Only non-mobile devices”
Device Location Info Present=0
Coverage Radius=−62 dBm; Coverage Sector=North and East
Target Device Count (N)=0
Include SBP Initiator bit=1
Include R2R bit=1
Number of Measurement links=3.

Based on the specified target selection criteria, the target coverage area 2706 can be determined from the coverage radius parameter (since the Device Location Info is not present, AP-1's location is taken as the centre of the target coverage area), and AP1 selects 3 links (AP1-STA8 link 2706, AP1-STA9 link 2707 and STA8-STA9 link 2708) for the SBP measurement. Similarly, the SBP initiator may also include the similar parameters as its target selection criteria to AP2 and setup SBP with AP2 with one link (AP2-STA1 link 2708) for the SBP measurement.

In another example, which can be implemented as a continuation of the first example, STA8 may be implemented as a motion detection sensor and obtains the sensing measurement results from the 3 selected SBP links (AP1-STA8 link, AP1-STA9 link and STA8-STA9 link), for example, through an SBP procedure according to the first example implementation, but determines that the sensing measurement results on the AP1-STA9 link and STA8-STA9 link do not show much perturbations (e.g., because the human entering the entrance/lobby area is far from the link). The SBP Initiator (STA8) may then decide that STA5 would be a better choice than STA9 for SBP measurement. STA8 then (re-)initiates a new SBP Setup with AP1, for example after terminating the earlier SBP setup.

The SBP Initiator includes the following Target Device parameters and Link parameters as its target selection criteria to AP1 in the new SBP Request frame:
Device Type=“Include all types”
Device Location Info Present=Coverage Info Present=0
Target Device Count (N)=3
Include SBP Initiator bit=1
Include R2R bit=1
Number of Measurement links=3
Target Device Info 1,2,3=STA8, STA5; STA5, STA8 (R2R link).

The SBP Initiator directly specifies the target STAs to be used as sensing responders for the SBP procedure. Based on the specified target selection criteria (i.e, the Target Device Info), AP1 selects 3 links (AP1-STA8 link 2706, AP1-STA5 link 2709 and STA8-STA5 link 2710) for the SBP measurement.

FIG. 27B shows another example format of an SBP Request frame 2750 according to the second embodiment. In the above second example, after the SBP Initiator (STA8) decides that STA5 would be a better choice than STA9 for SBP measurement, instead of terminating the existing SBP procedure, the SBA initiator may also choose to make changes to the existing SBP procedure, and transmit the SBP Request frame 2750 in which a Re-Setup bit field 2752 is set to 1 to indicate that this is not a new SBP Request but rather a request for change of SBP parameters. When the Re-Setup bit field 2752 is equal to 1, the Measurement Setup ID field is present in the SBP Request frame and indicates the Measurement setup id corresponding to the SBP procedure to be re-setup. The SBP Initiator includes the following Target Device parameters and Link parameters as its target selection criteria to AP1 in the SBP Request frame for SBP Re-setup:
Device Type=“Include all types”
Device Location Info Present=Coverage Info Present=0
Target Device Count (N)=3
Include SBP Initiator bit=1
Include R2R bit=1
Number of Measurement links=3
Target Device Info 1,2,3=STA8, STA5; STA5, STA8 (R2R link).

Upon receiving this SBP Request frame, the SBP Responder (AP-1) compares the STAs specified in the Target Device Info and figures out that the SBP Initiator is requesting to remove the sensing responder STA-9 from the current SBP procedure and instead intends to use STA-5 as the second sensing responder for the SBP procedure. Based on the specified the Target Device Info, AP1 transmits a Sensing Termination frame to STA-9 to terminate its sensing measurement setup with STA-9 for the M.S. ID corresponding to the SBP procedure. The AP1 also perform a sensing measurement setup with STA-5 to add it as a new sensing responder for the SBP procedure corresponding to the M.S. ID. This use of the SBP Request re-setup has the advantageous effect of modifying the SBP parameters without needing to terminate the SBP procedure and perform a new SBP setup.

In the following paragraphs, a third embodiment of the present disclosure where a sensing by proxy procedure, where a non-AP STA negotiates one SBP procedure for one measurement link at a time, is described. Different Measurement Setup IDs are assigned to different measurement links for the SBP procedure. The Measurement Setup IDs can then be used to identify the measurement link corresponding to a Sensing Measurement Report.

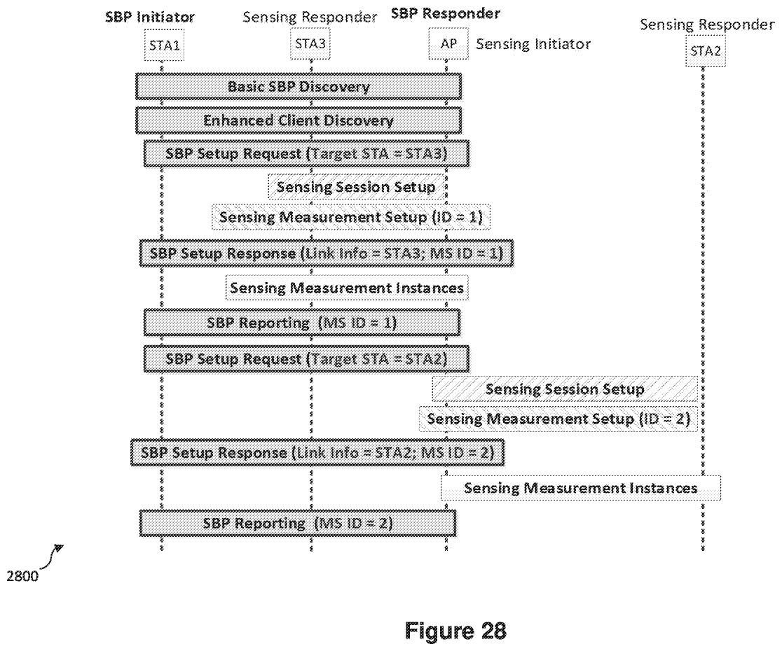

FIG. 28 shows a flowchart 2800 illustrating an overview of a sensing by proxy procedure between an AP and three non-AP STAs (STA1, STA2, STA3) according to the third embodiment of the present disclosure. First, a Basic SBP Discovery is carried out to discover the AP's support of the SBP function. The STA1 may then select the AP as its SBP responder. STA1 may then initiate an enhanced client discovery procedure to request the AP to provide a list of non-AP STAs (associated non-AP STAs and optionally unassociated non-AP STAs), and discover the basic information of AP and potential sensing responders.

STA1 discovers AP through the client discovery procedure and select it as the SBP responder. It then initiates an SBP procedure and requests the AP to perform a sensing measurement with a particular target sensing responder (in this case, STA3) on its behalf by transmitting a Protected SBP Request frame carrying target device parameters such as location, coverage information and the target sensing responder's STA ID. Based on the target device parameters, the AP decides STA3 for the sensing measurement, and initiates a sensing session setup and a sensing measurement setup with the selected STA/link (STA3) by transmitting a Protected Sensing Measurement Setup Request frame to STA3. The AP assigns a unique sensing measurement setup ID (M.S. ID “1’) to the STA/link. The AP then transmits a Protected SBP Response frame to indicate a successful setup with the sensing responder, the sensing responder's link information and their measurement setup ID (“2”) back to STA1 to complete the SBP setup.

Subsequently, the AP perform a sensing measurement with STA3 and transmits an SBP Report after collecting the measurement report on the link. In the report frame, the Measurement Setup ID (“1”) of the link/STA is included for identifying the measurement link.

Next, STA1 initiates a second SBP procedure and requests the AP to perform sensing measurement with another particular target sensing responder (in this case, STA2) on its behalf by transmitting a Protected SBP Request frame carrying target device parameters such as location, coverage information and the target sensing responder's STA ID. Based on the target device parameters, the AP decides STA2 for the sensing measurement, and initiates a sensing session setup and a sensing measurement setup with the selected STA/link (STA2) by transmitting a Protected Sensing Measurement Setup Request frame to STA2. The AP assign a unique sensing measurement setup ID (M.S. ID “2’) to the STA/link. The AP then transmits a Protected SBP Response frame to indicate a successful setup with the sensing responder, the sensing responder's link information and their measurement setup ID (“2”) back to STA1 to complete the SBP setup.

Subsequently, the AP perform a sensing measurement with STA2 and transmits an SBP Report after collecting the measurement report on the link. In the report frame, the Measurement Setup ID (“2”) of the link/STA is included for identifying the measurement link.

In this third embodiment, a selected sensing responder (e.g., STA2) may also need to verify whether the SBP initiator (e.g., STA1) is authorized to obtain the sensing measurement reports that involves itself. As such, during sensing measurement setup phase after receiving an SBP Request frame from the SBP Initiator, a sensing measurement setup request frame sent to the sensing responder (e.g., STA2) carries the ID (e.g., MAC Address) of the SBP initiator so that the selected sensing responder can verify whether the SBP initiator is so authorized.

Additional authorization validation frames (e.g., requesting/carrying a password) exchanges may also be performed between the sensing responder and the SBP Initiator (via the AP). If the Authorization Validation is successful, the sensing responder accepts the Measurement Setup Request and the SBP Setup is successful. If the Authorization Validation is unsuccessful, the sensing responder rejects the Measurement Setup Request and the SBP Setup fails.

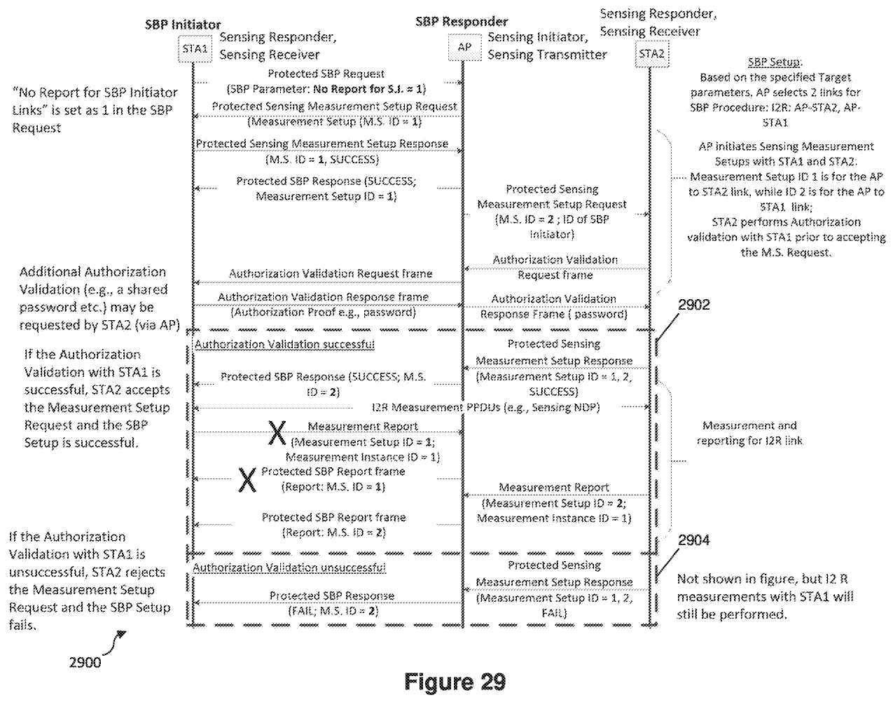

FIG. 29 shows a flowchart 2900 illustrating a detailed procedural flow of the sensing by proxy procedure between an AP being an SBP responder and two non-AP STAs (STA1 being an SBP initiator and STA2 being a sensing responder), according to the third embodiment of the present disclosure. After basic and enhanced client discovery procedures (not shown), STA1 initiates an SBP procedure and requests the AP to be a proxy sensing initiator on its behalf by transmitting a Protected SBP Request frame. Based on the specific Target Device parameters in the SBP Request frame, the AP selects two STAs/links that are more relevant for the sensing measurements (in this case, an AP-to-STA1 I2R link which is attached to itself (STA1), an AP-STA2 I2R link).

It is noted that the SBP initiator (STA1) may either be associated with the AP (SBP Responder) in which case it is assumed to have already completed the usual authentication/association procedure with the AP as well as setting up of security association (SA), for example, through a 4-way handshake prior to the initiation of the SBP Request; Or, it may be unassociated with the AP in which case it is assumed to have already completed the setting up of security associated with the AP, for example, through a pre0-association security negotiation (PASN) through a 3-way handshake prior to the initiation of the SBP request.

In this third embodiment, similar to the second embodiment, a unique measurement setup ID (M.S. ID) is assigned to each measurement link. For example, the AP-to-STA1 I2R link is assigned to M.S. ID “1”; the AP-to-STA2 link is assigned to MS. ID “2”. Unlike the second embodiment, the SBP Responder performs separate sensing procedures for different STAs/links.

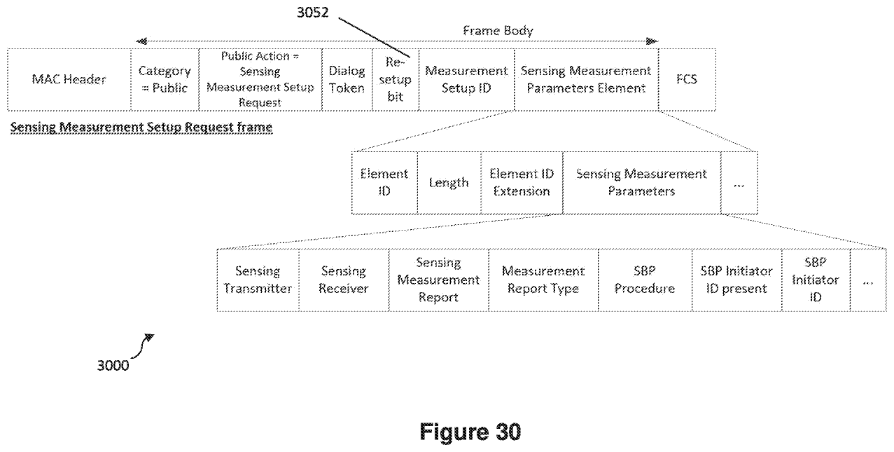

FIG. 30 an example format of a Sensing Measurement Setup Request frame 3000 according to the third embodiment of the present disclosure. The Sensing Measurement Setup Request frame 3000 comprises a MAC Header, a Category field which is set to “Public”, a Public Action field which is set to “Sensing Measurement Setup Request”, a Dialog Token field, a Re-Setup bit field, a Measurement Setup ID field, a Sensing Measurement Parameter Element field and a FCS field. The Sensing Measurement Parameters Element field comprises an Element ID field, a Length field, an Element ID Extension field, a Sensing Measurement Parameters field. The Sensing Measurement Parameters field comprises a Sensing Transmitter subfield, a Sensing Receiver subfield, a Sensing Measurement Report subfield, a Measurement Report Type subfield, an SBP Procedure subfield, an SBP Initiator ID Present subfield and an SBP Initiator ID subfield. The SBP Procedure subfield indicates that the Sensing Measurement Setup Request frame is for an SBP procedure and the SBP Initiator ID subfield indicates the SBP Initiator's ID. If the sensing initiator chooses to make changes to the attributes (parameters) of an existing sensing measurement setup, it transmits the Sensing Measurement Setup Request frame 3000 in which the Re-Setup bit field 3052 is set to 1 to indicate that this is not a new sensing measurement setup request but rather a request for change of sensing measurement setup parameters. When the Re-Setup bit field 3052 is equal to 1, the Measurement Setup ID field in the Sensing Measurement Setup Request frame indicates the Measurement setup id corresponding to the sensing measurement setup to be re-setup. This use of the sensing measurement setup request re-setup has the advantageous effect of modifying the sensing measurement setup without needing to terminate the sensing measurement setup and perform a new sensing measurement setup.

Returning to FIG. 29, the SBP Responder may first perform a sensing setup with STA1 and then another sensing setup with STA2. For the sensing setup with STA2, upon receipt of the Sensing Measurement Setup Request frame 3000, the sensing responder STA2 receiving the request may perform an Authorization Validation to verify whether the SBP Initiator (STA1) is authorized for the SBP procedure by transmitting a Protected Authorization Validation Request frame to the SBP Initiator (STA1 of FIG. 29) via the SBP Responder (AP of FIG. 29). Upon receipt of the Protected Authorization Validation Request frame, the SBP Initiator transmits a Protected Authorization Validation Response frame carrying the validation information (e.g., shared password) in the requested format back to the sensing responder via the SBP Responder.

If the Authorization Validation is successful, steps shown in block 2902 is carried out: otherwise step shown in block 2904 is carried out. In particular, if the Authorization Validation is successful, the sensing responder accepts the sensing measurement setup request and transmits a Measurement Setup Response frame comprising its Measurement Setup ID “2” assigned by the SBP Responder back to the SBP Responder to indicate that the SBP setup is successful. The SBP Responder then transmits a Protected SBP Response frame to the SBP Initiator to indicate that the SBP setup with the STA/link under the Measurement Setup ID “2” is successful.

If the Authorization Validation is unsuccessful, the sensing responder will transmit a Measurement Setup Response frame comprising its Measurement Setup ID “2” assigned by the SBP Responder back to the SBP Responder to indicate that the SBP setup fails. The SBP Responder then transmits a Protected SBP Response frame to the SBP Initiator to indicate that the SBP setup with the STA/link under the Measurement Setup ID “2” fails. However, even though the AP cannot perform sensing measurement on STA2 by proxy on behalf of STA1, I2R measurement and reporting between STA1 and AP is still able to be performed.

In one implementation, the Authorization Validation Request/Response may be skipped if the AP has other means to verify the STA's authorization to obtain information about other STAs; for example, the AP may maintain a list of authorized devices, or it may consult with a list of authorized devices from a database on a server etc.

For STA1, upon receipt of the Sensing Measurement Setup Request 3000, STA1 accepts the Sensing Measurement Setup without exchanges of Authorization Validation frames, and transmits a Protected Sensing Measurement Setup Response frame comprising its Measurement Setup ID “1” assigned by the SBP Responder for the SBP procedure back to the SBP Responder to indicate that the SBP setup is successful. The SBP Responder then transmits a Protected SBP Response frame to the SBP Initiator to indicate that the SBP setup with the STA/link under the Measurement Setup ID “1” is successful.

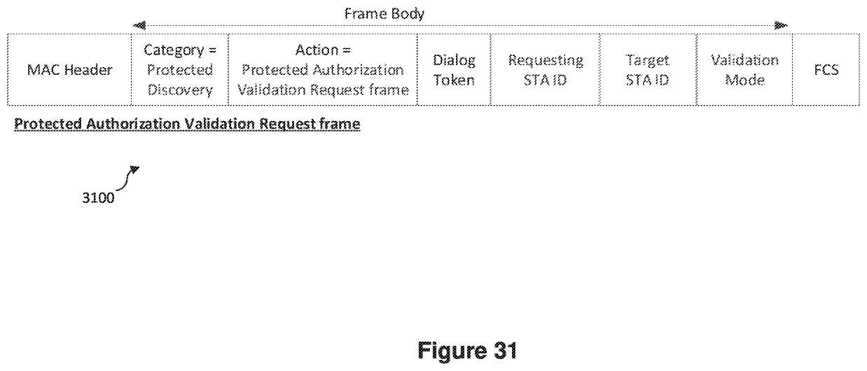

FIG. 31 shows an example format of a Protected Authorization Validation Request frame 3100 according to the third embodiment of the present disclosure. The Protected Authorization Validation Request frame 3100 comprises a MAC Header (Frame Control field, Duration field, RA field and TA field), a Category field which is set to “Protected Discovery”, an Action field which is set to “Protected Authorization Validation Request frame”, a Dialog Token field, a Requesting STA ID field, a Target STA ID field, a Validation Mode field and a FCS field.

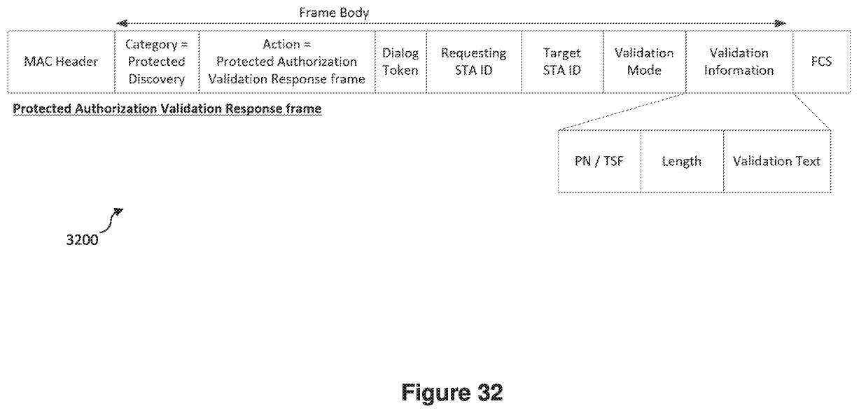

FIG. 32 shows an example format of a Protected Authorization Validation Response frame 3200 according to the third embodiment of the present disclosure. The Protected Authorization Validation Response frame 3200 comprises a MAC Header (Frame Control field, Duration field, RA field and TA field), a Category field which is set to “Protected Discovery”, an Action field which is set to “Protected Authorization Validation Response frame”, a Dialog Token field, a Requesting ID field, a Target ID field, a Validation Mode field, a Validation Information field and a FCS field. The Request STA ID of the Authorization Validation frames 3100, 3200 indicates the ID (e.g., MAC address) of the STA requesting the validation. The Target ID of the Authorization Validation frames 3100, 3200 indicates the SBP Initiator STA's ID (e.g., MAC address). The Validation Mode is set to 0 to indicate a plaintext password and 1 to indicate a hashed password. The Validation Information of the Authorization Validation Response frame 3200 comprises a PN/TSF field, a Length subfield and a Validation Text subfield. The PN/TSF field carries the Packet Number or the Time Synchronization Function that is used as salt to prevent replay attacks. The Length subfield indicates the length of the text in the Validation Text subfield. The Validation Text subfield carries the plaintext password or hashed password based on the Validation Mode field.

For example, a Hashed password is SHA-256(Key, PN/TSF ∥ “Plain text password), where Key is a common private secret key known to both parties, e.g., a PTK generated during the Security Association, or it may be a dedicated secret key to be used for sensing provided by the AP/upper layer application, “∥” is a concatenation action, and PN/TSF is the value of the PN/TSF field, and the transmitter should ensure that the same value is never used twice to prevent replay attacks. For e.g., it may be a monotonously increasing number, or may contain the current value of the transmitter's Time Synchronization Function (TSF).

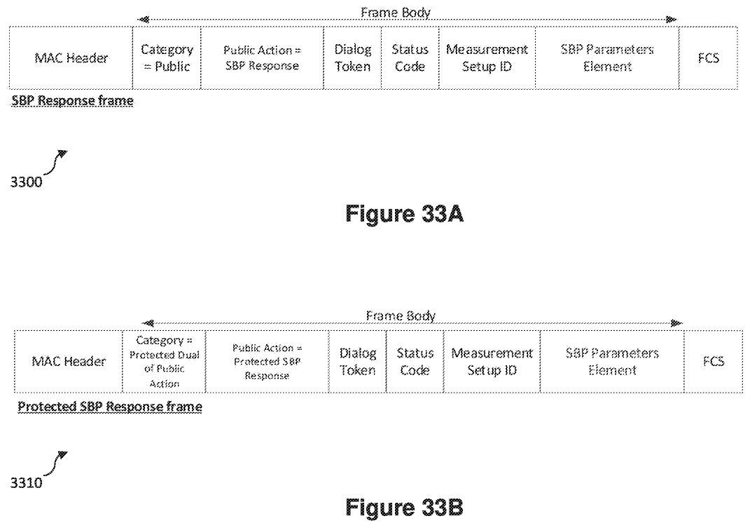

According to the third embodiment of the present disclosure, FIGS. 33A and 33B show example formats of an SBP Response frame 3300 and a Protected SBP Response frame 3310, respectively. The SBP Response frame 3300 comprises a MAC Header (Frame Control field, Duration field, RA field and TA field), a Category field which is set to “Public”, a Public Action field which is set to “SBP Response”, a Dialog Token field, a Status Code field, a Measurement Setup ID field and SBP Parameter Element field and a FCS field. The Protected SBP Response frame 3310 comprises a MAC Header (Frame Control field, Duration field, RA field and TA field), a Category field which is set to “Protected Dual of Public Action”, a Public Action field which is set to “Protected SBP Response”, a Dialog Token field, a Status Code field, a Measurement Setup ID field, an SBP Parameters Element field and a FCS field. The SBP Parameter Element field may be similar to that described in FIG. 15.

In this third embodiment, the SBP Initiator requests two separate SBP procedures and therefore two SBP response frames are transmitted for different STAs/links separately. The Measurement Setup ID field of each SBP response frame identifies the Measurement Setup ID value corresponding to the sensing measurement link assigned by the SBP responder and hence additional link information field is not included in the SBP Response frame.

Also, in one implementation according to the third embodiment of the present disclosure, when the SBP Initiator is one of the sensing responders (and also the sensing receivers), it is already aware of the result of the sensing measurements performed by itself, so the measurement reports for the I2R or R2R links, to which the SBP initiator is attached, need not be sent to the SBP Responder and the SBP Report does not require to include the measurement reports for such I2R or R2R links. This can be indicated by setting a “No Report for SBP Initiator Links” field in the SBP Request frame.

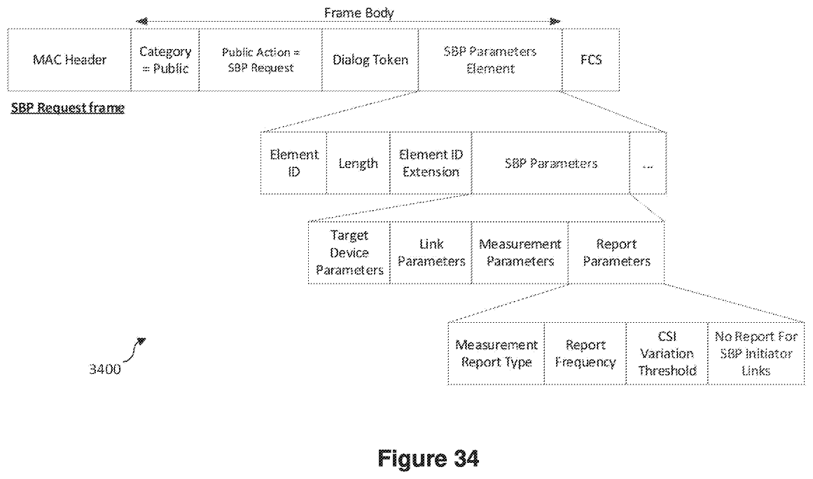

FIG. 34 shows an example format of an SBP Request frame 3400 according to the third embodiment of the present disclosure. The SBP Request frame 3400 comprises a MAC Header (Frame Control field, Duration field, TA field, RA field), a Category field which is set to “Public”, a Public Action field which is set to “SBP Request”, a Dialog Token field, an SBP Parameter Element field and a FCS field. The SBP Parameter Element field comprises an Element ID field, a Length field, an Element ID Extension field and an SBP Parameters field. The SBP Parameter field comprises a Target Device Parameters subfield, Link Parameters subfield, a Measurement Parameters subfield and a Report Parameter subfield which specify attributes related to the target STAs/links, the links to be measured, the measurement PPDUs and the SBP Reporting respectively.

In particular, the Report Parameters subfield comprises a Measurement Report Type subfield, a Report Frequency subfield, a Channel State Information (CSI) Variation Threshold subfield and an additional No Report For SBP Initiator Links subfield. If the No Report For SBP Initiator Links subfield is set to 1, the SBP Responder (AP) assigns the SBP Initiator as a sensing receiver in any R2R links or I2R links that involves the SBP Initiator and may not solicit sensing measurement reports from the SBP Initiator on such links. The SBP Responders also does not include the measurement report in the SBP Report frame for links with the SBP Initiator.

Returning to FIG. 29, in the SBP Request frame, the No Report For Initiator Links subfield of the SBP Parameter field is set to 1 indicating that the SBP Responder may not solicit sensing measurement report from the SBP Initiator on links attached to the SBP Initiator. Hence, during measurement instance, upon receipt of I2R Measurement PPDUs (e.g., sensing NDP) from the AP, STA1, which is the SBP initiator, does not transmit its measurement report to the AP on the I2R link. The SBP Responder also does not include the measurement report on the link to which STA1 is attached to the SBP Initiator.

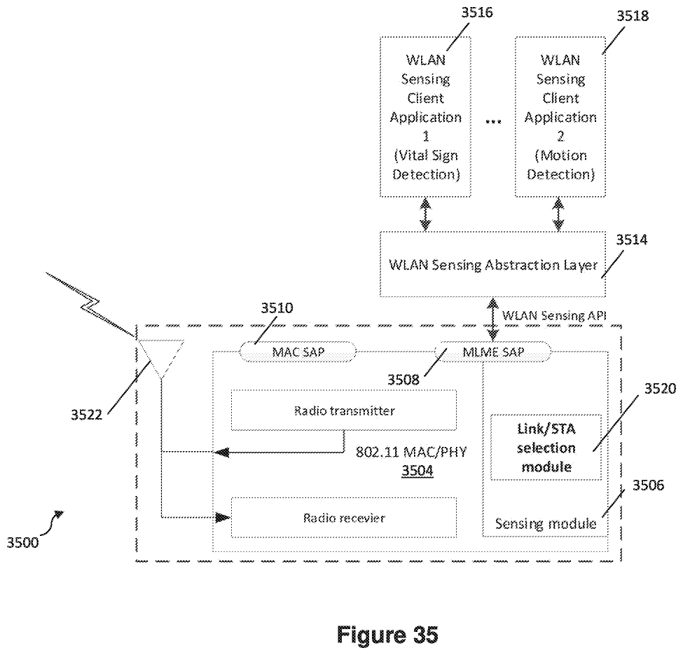

FIG. 35 shows an example configuration of a communication apparatus 3500. The communication apparatus 3500 is implemented as a STA for sensing by proxy in accordance with various embodiments of the present disclosure. The communication apparatus may include at least one antenna 3522 for transmission and receipt of signals (for the sake of simplicity, only one antenna is shown in FIG. 35). The communication apparatus 5200 further comprises 802.11 MAC/PHY sublayers 3504 comprising a Sensing module 3506 for channel measurements; layer management service interfaces such as MLME SAP 3508 and MAC SAP 3510 through which defined primitives are exchanged to pass information and layer management functions such as WLAN sensing may be invoked; and higher layer applications (e.g., WLAN Sensing Abstraction Layer 3514) communicating with the 802.11 MAC/PHY 3504 through MLME SAP 3508.

Further, the 802.11 MAC/PHY sublayers 3504 may communicate with WLAN Data Applications (not shown) through MAC SAP 5210. In this example, the Sensing module 3506 performs channel measurements and provides raw results to WLAN Sensing Abstraction Layer 3514 via WLAN Sensing API. The WLAN Abstraction Layer 3514 collects and consolidates the channel measurement results from 802.11 device and may process the results (e.g., smoothing compression etc.) before passing the processed results to WLAN Sensing Client Applications like WLAN Sensing Client Application 1 (Vital Sign Detection) 3516 and WLAN Sensing Client Application 2 (Motion Detection) 3516. The WLAN Sensing Client Applications like 3516, 3518 may perform WLAN Sensing based on the channel measurements (e.g., using application specific machine learning algorithms etc.) and provides the results of the WLAN sensing, in this case, presence/absence of human detection and human motion detection.

The communication apparatus further comprises a layer-dependent entity Station Management Entity (SME) (not shown) which perform functions on behalf of general system management entities and would implement standard management protocol such as to ensure correct MAC operation. The layer-dependent entity provides interfaces such as MLME SAP 3508 and PLME SAP (not shown) for exchanging primitives and communicating with MLME and PLME, respectively.

In one embodiment, the communication apparatus may be an SBP Initiator and the higher layer applications may issue MLME primitives (not shown), e.g., using MLME-SBP.request primitive, to initiate an SBP procedure.

The MAC/PHY Sublayer 3504 may be configured to receive information or WLAN sensing related MAC/PHY parameters to form an SBP request frame. The trigger frame or PPDU is then transmitted to one or more communication apparatuses (e.g., AP or SBP Responder), via at least one radio transmitter (not shown) through the antenna 3522.

The MAC/PHY Sublayer 3504 may also be configured to unpack response or measurement PPDU, e.g., SBP Response frame and SBP Report frame received from another communication apparatus, and pass the information related to the received PPDU to the Sensing module 3506.

The Sensing module 3506 further comprises a CSI feedback encode/decode module configured to decode and encode CSI information, e.g., information of a CSI sub-component (e.g., amplitude, phase, I and Q) indicated by a report type indicator, according to various embodiments above in the present disclosure.

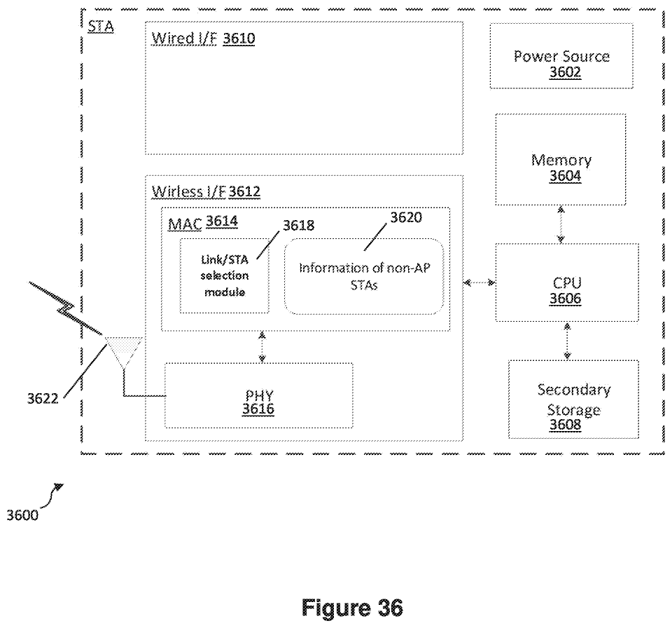

FIG. 36 shows another example configuration of a communication apparatus 3600. The communication apparatus 3600 is implemented as an AP or an SBP responder for sensing by proxy in accordance with the present disclosure. The communication apparatus 3600 comprises a power source 3602, a memory 3604, a CPU 3606 comprising at least one processor, a secondary storage 3608, a wired I/F 3610 and a wireless I/F 3612. The memory 3604 may be a non-transitory computer-readable storage medium having stored therein data representing instructions executable by the at least one processor of the CPU 3606 to communicate with the wireless I/F 3612 to perform multi-generation random access according to various embodiments in the present disclosure. The Wireless I/F 3612 comprises a MAC layer 3614 and a PHY layer 3616. The PHY layer 3616 connects with a radio transmitter (not shown), a radio receiver (not shown) and an antenna 3622 used for transmitting/receiving signals to/from other (base) communication apparatuses. Alternatively, the communication apparatus 3600 may transmit/receive signals to/from other communication apparatus via the Wired I/F 3610.

The MAC layer 3614 further comprises a Link/STA Selection Module 3618 and stores information of non-AP STAs 3620. The Link/STA Selection Module 3618 may be configured to generate and process frames (e.g., SBP request/response frames, Sensing measurement setup request/response frame, authorization validation request/response frames, measurement report, SBP report frame) and act as a proxy sensing initiator for an SBP initiator, utilize the information of non-AP STAs 3520 to perform sensing by proxy procedure for the SBP initiator according to various embodiments described above.

As described above, the embodiments of the present disclosure provide an advanced communication system, communication methods and communication apparatuses for sensing by proxy procedure in MIMO WLAN networks.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred to as a communication apparatus.

Some non-limiting examples of such a communication apparatus include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be understood that while some properties of the various embodiments have been described with reference to a device, corresponding properties also apply to the methods of various embodiments, and vice versa.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A first communication apparatus comprising:
circuitry, which, in operation, is configured to generate a request frame indicating a condition to be used by a second communication apparatus to select one or more links, each of the one or more links attached to one or more third communication apparatuses;
a transmitter, which, in operation, transmits the request frame to the second communication apparatus to request the second communication apparatus to perform a measurement on the one or more links; and
a receiver, which, in operation, receives a report frame from the second communication apparatus carrying one or more reports of the measurement corresponding to the one or more links.

2. The first communication apparatus of claim 1, wherein the condition relates to at least one of a link related parameter, a device related parameter, a number of links to be selected, a condition on whether a responder-to-responder (R2R) link can be selected, and a condition whether a link attached to the first communication apparatus can be selected.

3. The first communication apparatus of claim 2, wherein the link related parameter is at least one of a Received Signal Strength Indicator and a Received Channel Power Indicator received on a link, and the device related parameter is at least one of a device type, a device location, a device identifier and a device address.

4. The first communication apparatus of claim 1, wherein the report frame carries information identifying each of the one or more links corresponding to the one or more reports of the measurement.

5. The first communication apparatus of claim 4, wherein, prior to receiving the report frame, the receiver receives a response frame from the second communication apparatus carrying the information identifying each of the one or more links.

6. The first communication apparatus of claim 1, wherein the request frame further indicates whether the one or more reports carried in the report frame comprises a report of a measurement on a link to which the first communication apparatus is attached.

7. The first communication apparatus of claim 1, wherein, prior to receiving the report frame, the receiver further receives a validation request frame to request for verification information indicating that the first communication apparatus is authorized to receive the one or more reports; the circuitry is configured to process the validation request frame and generate a validation response frame comprising the verification information; and the transmitter transmits the validation response frame.

8. The first communication apparatus of claim 1, wherein the request frame is a Sensing By Proxy (SBP) Request frame; the response frame is an SBP Response frame and the measurement is a sensing measurement; and the report frame is an SBP Report frame.

9. The first communication apparatus of claim 1, wherein the first communication apparatus and the third communication apparatus are non-access-point (non-AP) stations and the second communication apparatus is an access point.

10. A second communication apparatus comprising:
a receiver, which, in operation, receives a request frame from a first communication apparatus, the request frame indicating a condition to select one or more links, each of the one or more links attached to one or more third communication apparatuses;
circuitry, which, in operation, is configured to generate a report frame carrying one or more reports of a measurement corresponding to the one or more links; and
a transmitter, which, in operation, transmits the report frame to the first communication apparatus.

11. The second communication apparatus of claim 10, wherein the circuitry is configured to select the one or more links based on the condition, and performs the measurement on the one or more links to obtain the one or more reports.

12. The second communication apparatus of claim 10, wherein, prior to generating the report frame, the circuitry is configured to generate a setup request frame for each of the one or more third communication apparatuses to setup the measurement on the each of the one or more third communication apparatuses, the setup request frame comprising an identifier of or an address of the first communication apparatus; and the transmitter transmits the setup request frame to the each of the one or more third communication apparatuses.

13. The second communication apparatus of claim 10, wherein the receiver receives a validation request frame from one of the one or more third communication apparatuses to request for verification information indicating that the first communication apparatus is authorized to receive a measurement report from the one of the one or more third communication apparatuses, and the transmitter transmits the validation request frame to the first communication apparatus; subsequently, the receiver further receives a validation response frame comprising the verification information from the first communication apparatus; and the transmitter transmits the validation response frame to the one of the one or more third communication apparatuses.

14. The second communication apparatus of claim 13, wherein the validation request frame and the validation response frame carry an identifier of or an address of each of the first communication apparatus and the one of the one or more third communication apparatuses.

15. The second communication apparatus of claim 10, wherein the report frame carries information identifying each of the one or more links corresponding to the one or more reports of the measurement.

16. The second communication apparatus of any one of claim 15, wherein the circuitry is configured to assign a different setup identifier to each of the one or more links, and generate a response frame subsequent to receiving the request frame comprising the different setup identifier assigned to the each of the one or more links; and the information carried in the report frame comprises the different setup identifier assigned to the each of the one or more links.

17. The second communication apparatuses of claim 10, wherein the request frame is a Sensing By Proxy (SBP) Request frame: the response frame is an SBP Response frame and the measurement is a sensing measurement; and the report frame is an SBP Report frame.

18. The second communication apparatus of claim 10, wherein the first communication apparatus and the third communication apparatus are non-access-point (non-AP) stations and the second communication apparatus is an access point.

19. A communication method implemented by a first communication apparatus comprising:
generating a request frame indicating a condition to be used by a second communication apparatus to select one or more links, each of the one or more links attached to one or more third communication apparatuses;
transmitting the request frame to the second communication apparatus to request the second communication apparatus to perform a measurement on the one or more links; and
receiving a report frame, from the second communication apparatus, carrying one or more reports of the measurement corresponding to the one or more links.

20. A communication method implemented by a second communication apparatus comprising:
receiving a request frame from a first communication apparatus, the request frame indicating a condition to select one or more links, each of the one or more links attached to one or more third communication apparatuses;
generating a report frame carrying one or more reports of a measurement corresponding to the one or more links; and
transmitting the report frame to the first communication apparatus.
